(19) United States
(12) Patent Application Publication
(10) Pub. No.: US 2025/0008321 A1
(43) Pub. Date: Jan. 2, 2025

(54) A METHOD FOR OPERATING A CELLULAR NETWORK

(71) Applicant: KONINKLIJKE PHILIPS N.V., EINDHOVEN (NL)

(72) Inventor: Oscar Garcia Morchon, Eindhoven (NL)

(21) Appl. No.: 18/695,009

(22) PCT Filed: Sep. 26, 2022
(86) PCT No.: PCT/EP2022/076630

§ 371 Date: Mar. 25, 2024

(30) Foreign Application Priority Data
Sep. 27, 2021 (EP) 21199194.8
Oct. 7, 2021 (EP) 21201483.1
Oct. 28, 2021 (EP) 21205309.4
Nov. 17, 2021 (EP) 21208847.0
Nov. 18, 2021 (EP) 21209081.5
Nov. 23, 2021 (EP) 21209743.0
Feb. 3, 2022 (EP) 22154888.6
Feb. 11, 2022 (EP) 22156421.4
Feb. 20, 2022 (EP) 22157640.8
Feb. 23, 2022 (EP) 22158360.2
Aug. 22, 2022 (EP) 2219357.7

(51) Int. Cl. H04W 12/04

(52) U.S. Cl. CPC H04W 12/04

(57) ABSTRACT

The invention relates to a method for operating a communication system including a. a first station preparing a message including a relay service code indicative of the type of service a user needs for relaying combined with a communication key or an indication of a communication key to be used for communication with a relay station: b. the first station generating a keystream by applying a key derivation function on at least a confidentiality key and freshness value, c. the first station ciphering the message with the key stream.

### FIELD OF THE INVENTION

The present invention relates to the field of wireless communications, and in particular to security aspects in the context of cellular networks, like the UMTS Long Term Evolution (LTE) or LTE Advanced (both included in 4G), New Radio (NR) (5G) or other cellular networks or mobile communication networks.

### BACKGROUND OF THE INVENTION

In conventional cellular networks, a primary station serves a plurality of secondary stations located within a cell served by this primary station. Wireless communication from the primary station towards each secondary station is done on downlink channels. Conversely, wireless communication from each secondary towards the primary station is done on uplink channels. The wireless communication can include data traffic (sometimes referred to User Data), and control information (also referred sometimes as signalling). This control information typically comprises information to assist the primary station and/or the secondary station to exchange data traffic (e.g. resource allocation/requests, physical transmission parameters, information on the state of the respective stations).

In the context of cellular networks as standardized by 3GPP, the primary station is referred to a base station, or a gNodeB (or gNB) in 5G (NR) or an eNodeB (or eNB) in 4G (LTE). The eNB/gNB is part of the Radio Access Network RAN, which interfaces to functions in the Core Network (CN). In the same context, the secondary station corresponds to a mobile station, or a User Equipment (or a UE) in 4G/5G, which is a wireless client device or a specific role played by such device. The term “node” is also used to denote either a UE or a gNB/eNB.

Additionally, for example, in the case of PC5 interface or Sidelink communication, it is possible to have Direct communication between secondary stations, here UEs. It is then also possible for UEs to operate as Relays to allow for example out of coverage UE to get an intermediate (or indirect) connection to the eNB or gNB. To be able to work as a relay, a UE may use discovery messages to establish new connections with other UEs.

Therefore, the role of a relay node as shown on FIG. 1 has been introduced in 3GPP. This relay node 120 is a wireless communication station 120 that includes functionalities for relaying communication between a primary station 100, e.g. a gNB and a secondary station 110, e.g. a UE. This relay function for example allows to extend the coverage of a cell 10 to an out-of-coverage (OoC) secondary station 110. This relay node 120 may be a mobile station or could be a different type of device. In the specifications for 4G, the Proximity Services (ProSe) functions are defined inter alia in TS23.303, and TS24.334 to enable-amongst others-connectivity for the cellular User Equipment (UE) 110 that is temporarily not in coverage of the cellular network base station (eNB) 100 serving the cell 10. This particular function is called ProSe UE-to-network relay, or Relay UE for short. The Relay UE 120 relays application and network traffic in two directions between the OoC UE 110 and the eNB 100. The local communication between the Relay UE 120 and the OoC UE 110 is called device-to-device (D2D) communication or Sidelink (also known as PC5) communication in TS23.303 and TS24.334. Once the relaying relation is established, the OoC-UE 110 is, e.g., IP-connected via the Relay UE 120 and acts in a role of “Remote UE” 110. This situation means the Remote UE has an indirect network connection to selected functions of the Core Network as opposed to a direct network connection to all Core Network functions that is the normal case.

Further, it has been introduced the role of a UE to UE relay node, i.e., a relay node relaying the communication between two UE devices. This is as illustrated in FIG. 3 where the relay node 1010 relays the communications between UE devices 1020 and 1030. UEs 1010, 1020, 1030 can connect to the core network through a base station 1000.

As will be detailed later, Technical Specification TS33.303 and solutions proposed so far describe the protection of discovery messages over PC5 interface by reusing already introduced methods of earlier versions of TS 33.303 with certain changes in the part of the message that is scrambled, how a Message Identification Code, MIC, is computed, which MIC value is transmitted, and how confidentiality protection is achieved. However, the currently proposed solutions are prone to attacks and the integrity of the various nodes involved in the discovery is not ensured. Furthermore, existing solutions in TS 33.303 are not capable of protecting long discovery messages, e.g., messages longer than 32 bytes.

As will be detailed later, Technical Specification TS 33.303 and solutions proposed so far describe the protection of Direct Communication Request messages over the PC5 interface. However, the currently proposed solutions lack interoperability and exhibit a too high complexity.

### SUMMARY OF THE INVENTION

One aim of the present invention is to alleviate the above mentioned problems.

Another aim of the present invention is to propose a method for communicating in a network that allows a secure set up for the establishment of a protocol data unit (PDU) session for a secondary station.

Still another aim of the invention is to better protect discovery messages.

Still another aim of the invention is to better protect discovery communication request (DCR) messages.

Still another aim of the invention is to propose a method of a secondary station for communicating in a network which requires minimal interaction with the Core Network once in operation.

It is proposed in accordance to various aspects of the invention some modifications of the security routines to make them work operationally and improve security/privacy protection and performance.

To this end, it is proposed in accordance with a first aspect of the invention, it is proposed a method for operating a first station as claimed in claim 1. More specifically, it is proposed a method for operating a first station in a communication system including the first station and a second station, said method including
a. the first station preparing a message including at least a parameter indicative of a type of service combined with a communication key or an indication of a communication key to be used for communication with the second station;
b. the first station performing an algorithm to generate a keystream by applying a key derivation function on at least a confidentiality key and freshness value,
c. the first station ciphering the message with the keystream.

In a first variant of the first aspect of the invention, step b. comprises generating the keystream by applying a key derivation function on at least a confidentiality key, a freshness value and the message.

In a second variant that can be combined with the first variant, step c. includes applying an exclusive OR (XOR) operation on the message and the keystream.

In all the above proposals, the freshness value may be a time value based on the UTC (Coordinated Universal Time).

Further, in a fourth variant that can be combined with the first aspects or any of its variants, the method comprises the first station computing a Message Integrity Check for the message.

In an example of this fourth variant, the Message Integrity Check may be included in the message before step c. Further, step b may include generating the keystream by applying a key derivation function on at least a confidentiality key, a freshness value, the message and its MIC.

In a fifth variant of the first aspect or its variants, step b. comprises selecting the confidentiality key from multiple available keys according to a predefined policy.

In such a variant, the confidentiality key may be a DUCK (which is an encryption key) if a DUCK is configured, and otherwise the confidentiality key is a DUSK (scrambling key) if a DUSK has been configured. Thus, the transmitter and the receiver know which of the keys is to be used, depending on which key(s) has(ve) been configured and agreed on. Additionally or optionally, the keystream may also be obtained by applying an encryption algorithm if the DUCK is configured and wherein the keystream may be obtained by applying a scrambling algorithm if the DUCK is not configured and if the DUSK has been configured.

In a further option, in the eventuality that no confidentiality has been configured (neither DUCK nor DUSK), the message in Step a. is not ciphered in Step c.

In a sixth variant which can be combined with any of the previous variants, the keystream may be obtained by applying a single algorithm regardless of the confidentiality key that has been configured. Indeed, the same algorithm can be used using whichever key is configured. This algorithm uses whichever key has been configured or selected indifferently.

In a seventh variant of the first aspect of the invention, the method comprises the first station computing a Message Integrity Check for the message using an integrity key, wherein the integrity key is the same as the selected confidentiality key.

In an eighth variant of the first aspect of the invention, step b. comprises applying a key derivation function to obtain a second confidentiality key and the keystream is obtained by applying the second confidentiality key to a symmetric encryption algorithm.

In an option of the eighth variant, the symmetric encryption algorithm is an NEA algorithm that has been selected by the core network or negotiated during a prior operation phase or signaled in the message.

In a ninth variant of the first aspect which can be combined with any of the previous variants, the parameter indicative of the type of service is a relay service code.

In accordance with a second aspect of the invention, it is proposed a first station as claimed in claim 17, for operating in a communication system further including a second station comprising
a transmitter,
a receiver,
a processor coupled to a memory including instructions for performing the steps of:
preparing a message including a parameter indicative of the type of service combined with a communication key or an indication of a communication key to be used for communication with the second station;
performing an algorithm to generate a keystream by applying a key derivation function on at least a confidentiality key and freshness value, ciphering the message with the keystream.

In accordance with a third aspect of the invention, it is proposed a second station as claimed in claim 18 for operating in a communication system further including a first station comprising
a transmitter,
a receiver,
a processor coupled to a memory including instructions for performing the steps of:
receiving a ciphered message;
performing an algorithm to generate a keystream by applying a key derivation function on at least a confidentiality key and freshness value, and
deciphering the message with the keystream.

It is to be noted that the various variants of the first aspect equally apply to the second and third aspect of the invention.

In a fourth aspect of the invention, a system as claimed in claim 19 is proposed.

In a fifth aspect of the invention, it is proposed a method as claimed in claim 20 for a first station sending a message to a second station in a communication system, the method comprising
a. the first station computing a Message Integrity Check, MIC, on the basis of a message;
b. the first station combining the MIC with the message
c. compute a keystream at least on the basis of the MIC,
d. the first station ciphering the message using a key word that is based on the keystream to obtain a cipher.

In a first variant of the fifth aspect of the invention, the method further comprises step e of scrambling a part of the cipher obtained from step d.

In a second variant of the fifth aspect of the invention, wherein the MIC is used as fingerprint of the message in the computation of the keystream.

In a third variant of the fifth aspect of the invention which may be used independtly or in combination with the other variants, wherein the key word is a combination of the key stream with an encryption key mask. Optionally, the combination is an AND operation.

In a sixth aspect of the invention, it is proposed a method for operating a first station in a communication system, the method including
a. the first station preparing a discovery message of length L bytes;
b. the first station generating a pseudorandom sequence whose output size is L bytes by applying a key derivation function of size B bytes Ceiling (L/B) times or a NEA algorithm and where the pseudorandom sequence is dependent on at least a confidentiality key and a freshness value and a counter value,
c. the first station ciphering the message with the pseudorandom sequence.

In a first variant of the sixth aspect of the invention, the input to the key derivation function includes the result of the application of a bitwise “AND” function to a mask and to the concatenation of message and MIC.

In a second variant which may be combined with the first variant, the input to the key derivation function or NEA algorithm includes a function of at least a mask, or a message, or a MIC.

In a third variant which may be combined with the first or second variant, the message indicates the message length or a mask indicating the presence of optional fields to adjust the ciphering operation.

In a seventh aspect of the invention, it is proposed a method for operating a system comprising a first station operating according to the method of the sixth aspect, and including a second station performing the steps of
a. receiving a discovery message;
b. descrambling and/or decrypting a first part of the discovery message by using a first part of the generated pseudorandom sequence,
c. verifying the integrity of the first part of the discovery message by means of a MIC in the first part of the discovery message;
d. descrambling and/or decrypting the second part of the discovery message with a second part of the generated pseudorandom sequence if the integrity check of the first part of the discovery message is successful and/or if a field in the first part of the discovery message indicates the presence of a second part of the discovery message.

In a first variant of the seventh aspect, the received second part of the discovery message is descrambled and/or decrypted if the hash of the received scrambled/encrypted second part of the message matches a hash value included and verified in the first part of the discovery message.

In a variant of fifth or sixth aspect of the invention, step a includes computing a MIC on the basis of the message and an integrity Key, DUIK, if available, and step a includes setting the MIC is to a random value if the DUIK is not configured. Optionally, the keystream is computed by means of a NEA algorithm.

Additionally, the 32-bit count in the NEA algorithm may be set to the UTC based counter value and a BEARER field value is set to BEARER=0000, and DIRECTION field value is set to 0.

In an option of the fifth or sixth aspects, the protection of the discovery message is first applied to the first part of the message and then to the second part of the message and the first part of the message and the second part of the message are differently protected.

In an eighth aspect of the invention, it is proposed a first station operating in a communication system comprising
a transmitter,
a receiver,
a processor coupled to a memory including instructions for performing the steps of:
a. the first station computing a Message Integrity Check, MIC, on the basis of a message;
b. the first station combining the MIC with the message
c. compute a keystream at least on the basis of the MIC,
d. the first station ciphering the message using a key word that is based on the keystream to obtain a cipher.

In a ninth aspect of the invention, it is proposed a first station operating in a communication system comprising
a transmitter,
a receiver,
a processor coupled to a memory including instructions for performing the steps of:
preparing a discovery message of length L bytes;
generating a pseudorandom sequence whose output size is L bytes by applying a key derivation function of size B bytes Ceiling (L/B) times or a NEA algorithm and where the pseudorandom sequence is dependent on at least a confidentiality key and a freshness value and a counter value,
ciphering the message with the pseudorandom sequence.

In a tenth aspect of the invention, it is proposed a second station operating in a communication system comprising
a transmitter,
a receiver,
a processor coupled to a memory including instructions for performing the steps of:
The second station receiving an encrypted message, a Message Integrity Check, MIC,
The second station obtaining a key word that is based on the MIC,
The second station decrypting the encrypted message with the obtained key word,
The second station checking if the received MIC is valid to check the integrity of the message.

In an eleventh aspect of the invention system claim comprising the first station of the eighth aspect of the invention and the second station of the tenth aspect.

In a twelfth aspect of the invention, it is proposed a computer program product comprising code adapted to cause when loaded on a wireless device said wireless device to perform the steps of the methods of the first.

In accordance with a second aspect of the invention, it is proposed a method for operating a relay station and a relay station.

In accordance with a third aspect of the invention, it is proposed a method for operating a secondary station and a secondary station.

In accordance with a fourth aspect of the invention, it is proposed a computer program product comprising code means for producing the steps of the method of the first, fourth, fifth sixth, or seventh aspects of the invention when run on a computer device.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the wireless device, the system, the relay station, the cell station and the method may have similar, corresponding and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the stations, the methods of the various aspects of the invention, the computer program product, and the system may have similar and/or identical preferred embodiments, in particular, as defined in the dependent claims.

These and other aspects of the invention will be apparent from and elucidated with reference to the embodiments described hereinafter.

### BRIEF DESCRIPTION OF THE DRAWINGS

FIG. 1, already described, schematically represents a cellular system in which the invention is implemented;

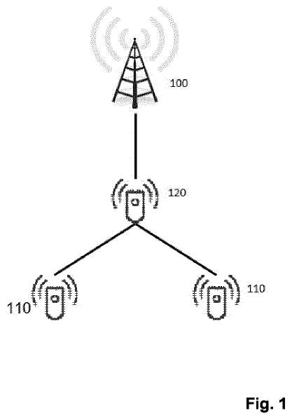

FIG. 2 schematically represents a discovery message;

FIG. 3 schematically represents another cellular system in which the invention is implemented.

### DETAILED DESCRIPTION OF THE INVENTION

The various aspects of the invention will be elaborated in the following embodiments. As explained earlier, the embodiments of the invention can be related to various types of wireless communication, and in particular to the connection setup of devices trying to access a wireless network. A typical example is a cellular network, for example a 5G network, possibly including some relay nodes. These relay nodes may be implemented by UEs, such as Sidelink compatible UEs which can operate as relay nodes, or by other types of repeaters.

To allow a new connection through this kind of relay, a discovery phase is required where discovery messages may be sent to the relay UE or by the relay UE. One general aim of this particular exemplary embodiment is to increase the protection of such discovery messages. The Technical Specifications TS 33.303 v17.0.0 describe in Section 6.1.3.4.3 the protection of the discovery messages. It lists three types of security used to protect the restricted discovery messages detailed as follows:

Firstly, integrity protection is provided by appending a MIC (Message Identification Code) as in Open Discovery (see subclauses 6.1.3.3.1). The MIC is calculated in the sending UE using a received Discovery User Integrity Key (DUIK) and may either be checked at the receiving UE using the supplied DUIK or at the ProSe Function (Relay node) using the DUIK.

Secondly, scrambling protection, which ensures that there is no relationship between the discovery messages sent by a particular UE, i.e. to prevent tracking of a UE over time. A scrambling keystream is calculated from the Discovery User Scrambling Key (DUSK) and the UTC-based counter associated with the discovery slot (see 6.1.3.4.3.5 for more details on the calculation).

Finally, message-specific confidentiality, which provides confidentiality protection for part of the discovery message. This is used either when several UEs use the same DUSK or if it is desired to obfuscate part of the discovery message from some of the UEs that are allowed to discover the UE. A keystream is calculated from the Discovery User Confidentiality Key (DUCK), the content of the message and the UTC-based counter associated with the discovery slot (see 6.1.3.4.3.6 for more details on the calculation).

The security procedures that are applied at the sending and receiving UE are controlled by the ProSe Function by sending the Code-Sending Security Parameters and/or Code-Receiving Security Parameters to the appropriate UE (i.e. the UE shall support all of integrity protection, scrambling and message specific confidentiality) To achieve integrity protection for a ProSe restricted discovery message, either a DUSK or a DUIK needs to be provided. When a DUCK is used to apply message specific confidentiality, a DUIK is required for integrity protection as more than one message is being protected. Examples of combinations of Discovery User Keys according to use case type is provided in Annex G.

At the receiving side, the scrambling protection must be undone before any matching can be attempted. Given that the operation of undoing message-specific confidentiality is computationally intense, the matching operation that precedes it should have a very minimal chance of a false positive. To this end, the ProSe Function should ensure the number of bits in a discovery message that can be matched after any scrambling has been undone is at least 16 (leading to a false positive chance of 1 in 65,536 or less).

In Clause 6.1.3.4.3.2, Message Processing in the sending UE, the UE sending a discovery message receives the Code-Sending Security Parameters from the ProSe Function (as described in the security flows) to indicate how to protect the message. The Code-Sending Security Parameters may contain a DUSK and may contain a DUIK. The Code-Sending Security Parameters may contain both, a DUCK and an Encrypted_bits_mask.

The UE sending a discovery message does the following steps:
1. Form Discovery Message (e.g. add Suffix if only Prefix was allocated).
2. Calculate MIC if a DUIK was provided, otherwise set MIC to all zeros
3. Add message-specific confidentiality to the message if DUCK was received
4. Append MIC to the output of step 3.
5. Add scrambling over the output of step 4 if the DUSK was received.

In Clause 6.1.3.4.3.3, Protected message processing in the receiving UE, the Code-Receiving Security Parameters received from the ProSe Function (as described in the security flows) are used to indicate to a UE how a received discovery message is protected. The Code-Receiving Security Parameters may contain a DUSK, may contain either a DUIK or an indication whether to use Match Reports for MIC checking. The Match Reports option is not allowed for ProSe Query Codes. The Code-Receiving Security Parameters may also contain both a DUCK and a corresponding Encrypted_bits_mask.

The UE receiving a Discovery Message does the following steps:
1. Undo scrambling (as in step 5 of sending UE) if a DUSK was received.
2. Check for match on the bits of the message that are not encrypted using message specific confidentiality. If no match, then abort.

Some bits that the discovery filter indicates to be matched, may be encrypted by message-specific confidentiality at this stage. The UE can look for a match on the other bits after this step to minimise the amount of processing performed before finding a match.
3. Undo message-specific confidentiality if a DUCK was received (as in step 3 of sending UE)
4. Check for full match if only a match on non-encrypted bits was found in 3. If no match then abort
5. If a MIC check is required, check MIC directly (if a DUIK was given in the Discovery Filter Security Parameters) or via Match Report if indicated in the Discovery Filter Security Parameters.

Requiring a checking of the MIC (at either the UE or via Match Reports) may only be omitted when the scrambling protection provides integrity protection of the bits of the message that are of interest to the receiving UE. Such integrity protection is only provided when (1) a given DUSK protects exactly one ProSe Code that the receiver matches, or (2) when message-specific confidentiality is applied to a ProSe Code but the receiving UE is not provided with the DUSK to remove the message-specific confidentiality and all the non-encrypted bits take a fixed value that the receiver matches. In the first case, if an attacker changes any bit of the message, the match will fail. In the second case, if an attacker changes a non-encrypted bit the match will fail and changing an encrypted does nothing as the receiving UE ignores these bits anyway. In latter case, the receiving UE could not successfully check the MIC.

In Clause 6.1.3.4.3.4, Integrity protection description, the sending UE does the following
1. Compute output bitsequence from DUIK, Message, and UTC-based counter passed through a MIC calculation function in Annex A.2.
2. Take the 4 bytes of the output of the function and set that as the value of the MIC for this Message.

The receiving UE or ProSe Function does the exact same steps but also does a comparison between the computed MIC and the received MIC.

In Clause 6.1.3.4.3.5, scrambling description, the sending UE does the following:
1. Set the 4 LSBs of the UTC-based counter equal zero, for the purpose of this scrambling calculation only.
2. Compute the time-hash-bitsequence from DUSK and the UTC-based counter (modified as in step 1), passed through a keyed hash function.
3. XOR the time-hash-bitsequence with the entire Discovery Message (including MIC) being processed.

The receiving UE does the exact same steps except applied to the received message being processed.

In Clause 6.1.3.4.3.6, message-specific confidentiality description, the sending UE does the following:
1. Compute Key_calc_mask=(Encrypted_bits_mask XOR 0xFF..FF)∥0xFFFFFFFF
2. Calculate Keystream=KDF (DUCK, UTC-based counter, (Key_calc_mask AND (Message∥MIC))).
3. XOR (Keystream AND Encrypted_bits_mask) into the Message.

The receiving UE does the exact same steps except applied to the received Discovery Message being processed”.

In above procedures KDF refers to a Key Derivation Function as will be described later.

Further, the calculation of the MIC is proposed to be defined as follows:

When calculating a MIC using the Discovery Key for open discovery
or the DUIK for restricted discovery, the following parameters shall be
used to form the input S to the KDF that is specified in Annex B of TS
33.220 [5]:

| | |
|---|---|
| - | FC = 0x49. |
| - | P0 = Message Type (see TS 24.334). |
| - | L0 = length of above (i.e. 0x00 0x01). |
| - | P1 = ProSe Application Code for open discovery or ProSe |
| | Restricted Code for restricted discovery. |
| - | L1 = length of above (i.e. 0x00 0x17). |
| - | P2 = UTC-based counter associated with the discovery slot. |
| - | L2 = length of above (i.e. 0x00 0x04). |

```
  The MIC is set to the 32 least significant bits of the output of the KDF.
  The Discovery Key, DUIK, Time parameter and discovery message
follow the encoding also specified in Annex B of TS 33.220 [5].
```

The calculation of the scrambling bits for discovery in this example is as in A.5:

When calculating the time-hash-bitsequence for discovery, the
following parameters shall be used to form the input S to the KDF that is
specified in Annex B of TS 33.220 [5]:

| | |
|---|---|
| - | FC = 0x4C |
| - | P0 = UTC-based counter for scrambling associated with the |
| | discovery slot - see subclause 6.1.3.4.3.5. |
| - | L0 = length of above (i.e. 0x00 0x04). |

```
  The input key shall be the 256-bit DUSK.
  The time-hash-bitsequence keystream is set to the 216 least significant
  bits of the output of the KDF.
```

The calculation of the message-specific confidentiality is in this example as in A.6 in TS 33.303:

When calculating the message-specific confidentiality keystream for
discovery, the following parameters shall be used to form the input S to
the KDF that is specified in Annex B of TS 33.220 [5]:

| | |
|---|---|
| - | FC = 0x4D |
| - | P0 = UTC-based counter associated with the discovery |
| | slot - see subclause 6.1.3.4.3.6. |
| - | L0 = length of above (i.e. 0x00 0x04). |
| - | P1 = (Key_calc_mask AND (Message \|\| MIC)) - see |
| | subclause 6.1.3.4.3.6 |
| - | L1 = length of above (i.e. 0x00 0x1B). |

```
  The input key shall be the 256-bit DUCK.
  The message-specific confidentiality keystream is set to the 184 least
  significant bits of the output of the KDF.
```

The length of Message∥MIC is 0x1B=16+11=27 bytes. This fits the fact that the MIC is 4 bytes and the Key_calc_mask is 23 bytes long as defined in E.5.2.2.27.

The contents in the Direct Communication Request (DCR) message—exchanged after the discovery messages—as described in TS 33.303 are not protected. In order to simplify these procedures and to increase the privacy protection, it has been proposed to reuse the DUCK or DUSK to protect the PRUK ID and RSC transmitted in the Direct Communication Request after the discovery phase. In such a case, it is possible to protect the RSC and PRUK ID in DCR message by using code-receiving security parameters. Thus, in this proposal, the Remote UE is required to operate as follows:
“If the Remote UE is provisioned with DUCK:
   1. Form Message=RSC∥PRUK ID
   2. Compute Key_calc_mask=(Encrypted_bits_mask XOR 0xFF..FF)∥0xFFFFFFFF
   3. Calculate Keystream=KDF (DUCK, UTC-based counter, (Key_calc_mask AND Message))—see subclause 6.Y.2.3.
   4. XOR (Keystream AND Encrypted_bits_mask) into the Message.
If the Remote UE is provisioned with DUSK:
   1. Set the 4 LSBs of the UTC-based counter equal zero, for the purpose of this scrambling calculation only.
   2. Compute the time-hash-bitsequence from Discovery User Scrambling Key (DUSK) and the UTC-based counter (modified as in step 1), passed through a keyed hash function as described in 6.Y.2.4.
   3. XOR the time-hash-bitsequence with the RSC and PRUK ID being processed.

The UE-to-network relay does the following to retrieve the RSC and PRUK ID from the received DCR:
If the U2N relay UE is provisioned with DUCK:
   1. Form Message=a part of protected (RSC∥PRUK ID) in the received DCR message.
   2. Compute Key_calc_mask=(Encrypted_bits_mask XOR 0xFF..FF)
   3. Calculate Keystream=KDF (DUCK, UTC-based counter, (Key_calc_mask AND (Message)))—see subclause 6.Y.2.3.
   4. XOR (Keystream AND Encrypted_bits_mask) into the Message.
If the U2N relay is provisioned with DUSK:
   1. Set the 4 LSBs of the UTC-based counter equal zero, for the purpose of this scrambling calculation only.
   2. Compute the time-hash-bitsequence from Discovery User Scrambling Key (DUSK) and the UTC-based counter (modified as in step 1), passed through a keyed hash function as described in 6.Y.2.4.
   3. XOR the time-hash-bitsequence with the scrambled part of RSC and PRUK ID in the received DCR″.

The discovery keys are generated from a PDSK as described in TS 33.303 v17.0.0 A.8:
“When calculating a DUSK, DUCK or DUIK from the PSDK, the following parameters shall be used to form the input S to the KDF that is specified in Annex B of TS 33.220 [5]:
FC=0x4F
P0=0x00 if DUSK is being derived, 0x01 if DUCK is being derived, or 0x02 if DUIK is being derived
L0=length of P0 (i.e. 0x00 0x01)
P1=algorithm identity
L1=length of algorithm identity (i.e. 0x00 0x01)

The algorithm identity shall be set to 0x00. Later releases may define other values.

The input key shall be the 256-bit PSDK.

For an algorithm key of length n bits, where n is less or equal to 256, the n least significant bits of the 256 bits of the KDF output shall be used as the algorithm key”.

The Key Derivation Function (KDF) described in above embodiments is defined in TS 33.220 v17.0.0 in Appendix B.2. The KDF of an input bit string S with a key K, i.e., KDF (K,S), is equivalent to HMAC-SHA-256 (K,S) where SHA-256 is the hash function used in the HMAC construction. The bit string S is constructed as described in TS 33.220 from multiple parameters param1, param2, . . . , paramN but concatenating those parameters with their assigned length and including a unique identifier denoted FC for the specific usage of the KDF. Sometimes, instead of writing KDF (K,S) it is written KDF (K, param1, param2, . . . , paramN) where it is to be understood that the bit string S is constructed with the field param1, param2, and so on.

The various keys mentioned above for integrity, confidentiality and scrambling (DUIK, DUCK and DUSK respectively) can be combined and defined as explicated in Appendix G in TS 33.303. More particularly, the various combinations are shown in the table below which provides details of the security provided and sample use case(s) for the various combinations of security mechanisms that are possible for Restricted Discovery and Public Safety Discovery. This table does not restrict the combination of security mechanisms that the UE supports for either Restricted or Public Safety Discovery

| Sending | Receiving | | Comments and/or |
|---|---|---|---|
| UE | Side | Security provided | example use case |
| DUIK | DUIK | Discovery message is only integrity protected. | Relay Discovery where the Relay |
| | | | has no requirement for tracking |
| | | | or confidentiality protection. |
| DUSK | DUSK | Hiding of the parts of the message that | Restricted discovery where |
| | | identify the user (e.g. ProSe Code) to prevent | exactly one ProSe code is |
| | | the user being discovered or tracked by | protected by thisDUSK. |
| | | unauthorised users. Note: only works if there | |
| | | is exactly one message to be protected with | |
| | | the DUSK (as then the scrambling provides | |
| | | integrity protection). | |
| DUSK | DUSK | As above | As above |
| and | DUSK | Hiding of the parts of the message that | Restricted Discovery when one |
| DUIK | and | identify the user (e.g. ProSe Code) to prevent | user uses DUSK to send Code |
| | DUIK | the user being discovered or tracked by | with Application Controlled |
| | | unauthorised users. | Extension bits |
| | | When only one user uses the DUSK, it | |
| | | prevents tracking of the user. When multiple | |
| | | users are using the same DUSK, the XOR | Restricted Discovery with |
| | | difference between the unprotected discovery | several users sending unique |
| | | messages will be preserved and would enable | codes and no Application |
| | | some tracking of a user. | Controlled Extension bits. |
| | | Integrity protection of the whole message. | |
| | | Confidentiality protection of the whole | |
| | | message when only one user uses the DUSK | |
| DUSK, | DUSK | Hiding of the parts of the message that | DUSK applies to exactly one full |
| DUIK | | identify the user (e.g. ProSe Code) to prevent | code and ciphered Application |
| and | | the user being discovered or tracked by | Controlled Extension bits |
| DUCK | | unauthorised users. | included in the message but are |
| | | | not decryptable by a receiver |
| | | Note: only works if there is exactly one | that only gets DUSK, as it was |
| | | message to be protected with the DUSK (as | not given DUCK. |
| | | then the scrambling provides integrity | |
| | | protection) | |
| | DUSK, | Hiding of the parts of the message that | Restricted Discovery with more |
| | DUIK | identify the user (e.g. ProSe Code) to prevent | than one sender using the same |
| | and | the user being discovered or tracked by | DUSK and there are Application |
| | DUCK | unauthorised users. When only one user uses | Controlled Extensions bits that |
| | | the DUSK, it prevents tracking of the user. | are encrypted/decrypted using |
| | | When multiple users are using the same | DUCK. |
| | | DUSK, the XOR difference between the | |
| | | unprotected discovery messages will be | |
| | | preserved and would enable some tracking of | |
| | | a user. | |
| | | Integrity protection of the whole message, | |
| | | plus confidentiality protection of part of the | |
| | | message. | |
| DUCK | DUCK | Integrity protection of the whole message and | Group MEBMer Discovery where |
| and | and | confidentiality protection of part of the | the Discovery Group ID is sent in |
| DUIK | DUIK | message. | the clear and the rest of the |
| | | | message is protected by |
| | | | message-specific confidentiality. |

The “Sending UE” column describes what keys need to be known to the sending UE in the case of Restricted Discovery or signalled for use by the PKMF in the case of Public Safety Discovery. The “Receiving side” column shows what keys need to be sent to the receiving UE for Restricted Discovery, except if ProSe Function MIC checking is required (when the DUIK is kept at the ProSe Function in the HPLMN of the receiving UE), or signalled for use by the PKMF. The “Security provided” column details the security that this combination of security mechanisms provide. The final column provides example use case(s) where this combination of security mechanisms can be used.

### Problems Related to DCR Protection

In reference to solutions proposed to improved the protection of DCR messages over the PC5 interface by reusing the methods in TS 33.303, several issues arise from these proposed schemes, and that will be solved in the following embodiments of the invention.

First (Problem 1.1), as explained earlier the encryption algorithm, key_calc_mask is computed as Key_calc_mask=(Encrypted_bits_mask XOR 0xFF..FF)∥0xFFFFFFFF

However, the concatenation of 0xFFFFFFFF is not needed (since there is no MIC in contrast with TS 33.303 in the protection of the discovery messages). Furthermore, the length of 0xFF..FF is not specified.

Additionally, (Problem 1.2) the Encrypted_bits_mask is not defined and there is a need to have a method to generate this mask.

Further (Problem 1.3), the message is not integrity protected. Indeed, since the remote UE, i.e., the monitoring UE in discovery mode A or the discoverer UE in discovery mode B, might use match reports, the remote UE might not have a suitable DUIK, and thus, there is no way of applying integrity protection using the currently proposed routines or the current version of TS 33.303. The mere addition of a MIC with these schemes would not be efficient.

A further issue is that the previous proposal suggests that the DCR message can be confidentiality protected using either the DUSK or the DUCK using different algorithms. However, this has a number of issues that need to be fixed:

First, the scrambling algorithm using the DUSK computes a pseudorandom sequence dependent on the DUSK and a UTC-based counter with a granularity of 16 seconds and encrypts the message by XORing it with the pseudorandom sequence. The encryption algorithm using the DUCK computes a pseudorandom sequence dependent on the DUCK and a UTC-based counter with a granularity of 1 second and the RSC and encrypts the message by XORing it with the pseudorandom sequence. This increases the complexity of the solution since multiple algorithms can be used.

Second, a problem emerges when the remote UE and the relay UE have both the DUSK and the DUCK since it is not defined which key/algorithm it is to be used.

Another issue is that a remote UE or a relay UE might have multiple sets of discovery keys. Note that each set might be identified an identifier, e.g., by the PDSK ID since the DUSK, DUCK, and DUIK are derived from a PDSK as specified in TS 33.303 or Solution #37 in TR 33.847. As a consequence of having multiple sets of discovery keys, the relay UE might not know which keys of which discovery key set should be used to decrypt the DCR message.

An additional issue is linked to an input in the generation of the pseudorandom sequence used for encryption in combination of the DUCK is the RSC. Indeed, it might happen that a DUCK is used in combination with multiple RSCs thus the relay UE does not directly know which RSC should be used to generate the pseudorandom sequence used to decrypt the incoming message.

### Problems Associated to Ts 33.303 Security Routines for Discovery

Additionally, further problems arise from and in the current version of TS 33.303. In this version, processing a message when sending it is specified as follows: “Section 6.1.3.4.3.2 recites that in Step 2 the MIC is computed if DUIK is received (otherwise it is set to all 0s). Then in Step 3, message specific confidentiality is applied, if DUCK is received. Then in Step 4, MIC is appended. Then, in Step 5, the total output is scrambled if DUSK was received.” However, this leads to the following issues.

In an additional problem (Problem 2.1), the MIC is not encrypted, then it is possible for a passive attacker to directly observe if message is integrity protected or not, in particular, if scrambling is not used.

In an additional problem (Problem 2.2), even if the goal in TS 33.303 was to use the DUSK and the scrambling functionality to avoid leaking information, e.g., whether a message is integrity protected or not, since the scrambling sequence only changes every 16 seconds, while the encryption sequence changes every second (because of the UTC-based counter), and the MIC also changes every second (because of the UTC-based counter), then it is still feasible to observe if a message is integrity protected or not by monitoring whether the last 4 bytes of the messages broadcasted by a UE change every second or every 16 seconds.

In an additional problem (Problem 2.3), the field Encrypted_bits_mask might differ per device (or device class). If it is applied, then it is possible to identify (and/or track) a device based on its encrypted_bits_mask field. This is so since only the bits that are encrypted “change” once per second once the new encryption (due to the new counter) is applied. It is to be noted that tracking by an attacker is feasible even if scrambling is used. This is feasible since the scrambling sequence is stable for 16 seconds while the encryption sequence changes every second. In this time, it would be feasible for an attacker to determine the Encrypted_bits_mask field associated to a device. Every time a new scrambling sequence is applied, the attacker uses the 16 seconds to obtain the encrypted_bits_mask field and use it to identify/track the device.

In an additional problem (Problem 2.4) as in Problem 1.2, it is not specified what Encrypted_bits_mask is.

In an additional problem (Problem 2.5), the scrambling sequence only depends on the DUSK and UTC counter that only changes every 16 seconds. The DUSK might be shared by more than a device. Thus, it can happen that: 1) the same pseudorandom sequence is used by a device to scramble two different discovery messages or 2) the same pseudorandom sequence is used by two or more devices to scramble two or more different discovery messages. If this happens, it is possible to XOR the scrambled messages obtaining the XOR of the plaintext messages. When this happens, security protection is lost.

### Embodiments Improving Protection of DCR Message

Thus, an aim of a first embodiment of the invention is to design a method to generate the encrypted_bits_mask. In a first example, the encrypted_bits_mask can be defined as such that it sets to 1 a bit if the bit is to be encrypted, and to 0 if then bit is not to be encrypted. With this definition, the processing a message when sending can work if modified as follows:

TS33.303, Section 6.1.3.4.3.3, in Step 1 it has to undo scrambling, in Step 2 check for match on the bits that are not encrypted, in Step 3 undo confidentiality if DUCK was received, in Step 4 perform full match, and in Step 5 check MIC if DUIK given the Discovery Filter Security Parameters or via Match Report if indicated in the Discovery Filter Security Parameters.

Such a confidentiality algorithm can be as follows:
1. Compute KCM=(EBM XOR 0xFF..FF)∥0xFFFFFFFF
2. Calculate KS=KDF (DUCK, UTC-based counter, (KCM AND (Message∥MIC))).
3. C=Message XOR (KS AND EBM)

Assuming that KS is, e.g., 1010 1010 1010 1010 and EBM 1111 1111 0000 0000, then KS AND EBM=1010 1010 0000 0000. Then message XOR 1010 1010 0000 0000 if:
message=1111 1111 1111 1111 equals: 0101 0101 1111 1111
message=0000 0000 0000 0000 equals: 1010 1010 0000 0000

Without making this definition explicit, the wrong parts of the message might be encrypted (posing a security risk) and implementations might not be interoperable. The previously introduced proposals could be improved by defining as follows that In the encryption algorithm, key_calc_mask is to be computed as Key_calc_mask=(Encrypted_bits_mask XOR 0xFF . . . FF) where 0xFF . . . FF is as long as the concatenation of PRUK_ID and RSC.

In a further embodiment, the concatenation of 0xFFFFFFFF is not needed since proposed solutions to privacy protect the DCR do not include any MIC. In fact, if 0xFFFFFFFF is concatenated, the following step in the proposed algorithms:
Keystream=KDF (DUCK, UTC-based counter, (Key_calc_mask AND Message))
might not work in an interoperable manner since key_calc_mask is 4 bytes longer than message.

Alternatively, if it is aimed to encrypt both PRUK_ID and RSC, the encryption routine can be defined as:
1. Message=RSC (Relay service code Type of service that the user needs for relaying)∥PRUK ID (Key identifier used for the PC5 interface)
2. Calculate Keystream=KDF (DUCK, UTC-based counter, Message)
3. Ciphertext=Message XOR Keystream.

More generally, it is proposed in this embodiment a method for operating a communication system including
a. a first station preparing a message including a relay service code indicative of the type of service a user needs for relaying combined with a communication key or an indication of a communication key to be used for communication with a relay station;
b. the first station generating a keystream by applying a key derivation function on at least a confidentiality key and freshness value,
c. the first station ciphering the message with the key stream.

Another option is that Keystream is computed as KDF (DUCK, UTC-based counter) only where the string S used in the KDF is the concatenation of the following parameters:
FC=0xXX
P0=UTC-based counter
L0=length of above (i.e., 0x00 0x04).
P1=Message
L1=length of PRUK_ID and RSC.

And the Keystream is the L LSBs of the output of the KDF, where L is equal to L1. This definition avoids the computation of Key_calc_mask and simplifies the computation of the keystream value used for encryption.

Integrity protection is advisable when sending DCR message to (1) Prevent an attacker from modifying the encrypted contents; (2) prevent an attacker from replaying the DCR message/PRUK_ID and RSC values at a later point of time; or (3) prevent an attacker from replaying the DCR message/PRUK_ID and RSC values to a different relay UE.

If integrity protection is needed, an integrity key is required to compute a MIC. However, the DUIK, in contrast to DUSK and DUCK, might not always be available. There are multiple options to have a suitable integrity key to compute a MIC enhancing previous proposed schemes.

In a first option A), use a key available to both remote UE and relay UE (e.g., DUCK or DUSK) as a master key in combination with a KDF to derive two keys, an integrity key and a confidentiality key.

In a second option B), the discovery keys are enhanced with an additional key used for integrity protection of the DCR message. This key is denoted DUI_DCR_K.

In a third option C), the master key used to generate the existing discovery keys (DUIK, DUCK, DUSK) is also used to generate the DUI_DCR_K by means of a KDF.

In the above options, when the KDF is applied, the 3GPP KDF defined in TS 33.220 can be used.

According to this definition, the KDF takes as input a master key and a unique bitstring S. For instance, in the case that DUCK is used as master key, the bitstring S used to generate the integrity key might include a unique identifier FC associated with the purpose of the derived key (e.g., confidentiality protection of PRUK ID|RSC or integrity protection of PRUK ID|RSC), information to link the usage of the key to the previously sent discovery message, e.g., the key stream used to protect the discovery message with the DUCK, UTC-based counter.

In Option C), the DUI_DCR_K might be generated as in A.8 in TS 33.303 using a new P0 value associated to DUI_DCR_K, e.g., 0x03.

When the MIC of the DCR message is computed, it is meaningful to protect the PRUK_ID and RSC as well as other fields such as fields determining the source or the destination of the message. The MIC computation might take as input an UTC-based counter to avoid replay attacks. The MIC computation might also include a nonce previously sent by the relay UE during the discovery phase to achieve replay protection without the need of a time-based counter.

If the DCR message is confidentiality and integrity protected, the security routine should be:

Message = RSC || PRUK ID
Compute MIC using DUI_DCR_K for the given message.
Calculate Keystream = KDF (DUCK, UTC-based counter, Message|MIC)
Ciphertext = (Message|MIC) XOR Keystream.

Step 2 can use the MIC computation routine as in A.2 in TS 33.303 but using the DUI_DCR_K instead of the DUIK. The P0 and P1 values should indicate that it is a DCR message including PRUK_ID and RSC. Note that the MIC might also be computed including other parts of the DCR message that also need to be protected. For instance, the identity of the addressed relay UE. This prevents an attacker from replaying the message to other close by relay UEs.

Step 3 assumes that both message and MIC are encrypted. If only the message is encrypted and not the MIC, this can be indicated by concatenating a mask or a bit.

Step 4 assumes that both message and MIC are encrypted. If the MIC is not encrypted, the XOR should only be done on the message part.

We note that even if the RSC and PRUK_ID are not integrity protected by means of a MIC, some type of integrity protection might be achievable. The reason is that if an attacker modifies an encrypted message (e.g., by flipping a bit in the encrypted PRUK_ID or RSC field), this will lead to a different PRUK_ID and RSC. The relay UE might not be capable of such a modified RSC. Thus, in the case that MIC is not available/computed as in the previous proposals, it is advisable that the relay UE decrypts the encrypted fields and checks whether the received fields are as expected (e.g., an RSC value is present that was also negotiated in a previous discovery phase) or as supported (e.g., supported RSC values).

In an additional embodiment addressing this issue of additional complexity because of the usage of different algorithms, so called encryption or scrambling algorithms, either the DUSK or the DUCK or a combination of them are used to protect the confidentiality of the DCR message using a same algorithm. In particular, the algorithm can be, e.g., the encryption algorithm in TR 33.847.

Additional embodiments address the issue that is unclear which key/algorithm to use when the devices are configured with multiple keys in multiple ways:

An additional embodiment aiming at this issue consists in selecting the key to use according to a predefined preferred order, e.g., first attempt with DUCK, if DUCK available, and then attempt with the DUSK, if DUSK available. This can be done e.g., using the respective encryption and scrambling algorithms as in TR 33.847 or using the selected key in a single algorithm as proposed in the above Embodiment.

Another approach consists in applying a combination of both keys, if both keys are available. This can be done by, e.g., (i) first deriving a key dependent on both keys and then using the resulting key in the encryption algorithm, or by (ii) using both DUSK and DUCK in the generation of the pseudorandom sequence by using both keys as inputs in the KDF.

Another approach consists in the remote UE selecting the DUCK or the DUSK and signalling it to the relay UE, e.g., by including a bit set to, e.g., 0 (DUSK) or 1 (DUCK).

Another approach consists in the relay UE trying to decrypt the DCR message with both keys.

Additional embodiments addressing the issue that might have multiple sets of discovery keys are as follows:

First, the remote UE may add a field in the DCR messages that allows the relay UE to identify the correct set of discovery keys. This field can be PDSK ID.

Second, as above, but since exchanging the whole PDSK ID might lead to privacy issues, the remote UE might transmit a subset of the PDSK ID, e.g., the least significant bits allowing the relay UE to pick up the right set.

Third, the relay UE may keep track of the last distributed discovery messages, and the set of keys used to protect them. In particular, the relay UE can keep a list of keys in a FIFO mode, i.e., inserted and used according to their last usage: every time a different discovery DUSK or DUCK key is used in the discovery phase, that key is placed in the first place of the list and existing keys are pushed down in the list; when the relay UE receives a DCR message, the relay UE attempts decryption starting with the discovery keys that are on top of previous list.

The issue that a DUCK is used in combination with multiple RSCs can be solved by an embodiment in which the remote UE may add a field in the DCR messages that allows the relay UE to identify the correct RSC. This field can be a subset of the RSC, e.g., the least significant bits or an index indicating which of the RSCs is the one that is used. For instance, if a DUCK is associated to 3 RSCs RSC1, RSC2 and RSC3 whose values are RSC1<RSC2<RSC3, then RSCi can be linked to index i, with i=1,2,3.

The issue that a DUCK is used in combination with multiple RSCs can be solved by an additional embodiment in which the relay UE can keep track of the last distributed discovery messages, and the associated RSCs. In particular, the relay UE can keep a list of RSCs in a FIFO mode, i.e., inserted and used according to their last usage: every time a different RSC is announced in the discovery phase, that RSC is placed in the first place of the list and existing RSCs are pushed down in the list; when the relay UE receives a DCR message, the relay UE attempts decryption starting with the RSCs that are on top of previous list.

As in TS 33.303, the decryption algorithms perform the inverse operation done in encryption, i.e., they compute the same pseudorandom sequence, and then they obtain the plaintext by XORing the received ciphertext with the computed pseudorandom sequence.

Based on the above embodiments, a concrete implementation of the procedures to protect DCR message between a remote UE and a relay UE can be as follows:

In this example, the Remote UE does the following:

```
  Step 1. If DUCK available, set DUCK as key K. If DUCK is not
available, then choose DUSK as K. If neither DUCK nor DUSK are
available, the DCR message is not protected, and Steps 2-5 can be
skipped.
  Step 2. Form Message = RSC | | PRUK ID
  Step 3. Compute MIC = KDFDCR_Integrity(K, Message Type,
Message fields, UTC-based counter) as described below.
  Step 4. Calculate Keystream = KDFDCR_Confidentiality (K,
UTC-based counter, RSC) as described below.
  Step 5. Ciphertext = (Message | | MIC) XOR Keystream
```

The remote UE may then send the ciphertext, as part of the DCR message, to the UE-to-network relay.

On the receiving side, the UE-to-network relay may do the following to retrieve the protected fields of the received DCR message, e.g., RSC and PRUK ID:

```
Step 1. If DUCK available, set DUCK as key K. If DUCK is not available,
then choose DUSK as K. If neither DUCK nor DUSK are available, the
DCR message is not protected, and Steps 2-6 can be skipped.
Step 2. Form Ciphertext = a part of protected (RSC | | PRUK ID | | MIC)
  in the received DCR message.
Step 3. Calculate Keystream = KDF_{DCR}_{_{—}}_{Confidentiality} (K, UTC-based
  counter, RSC) as described below.
Step 4. Obtain MessageReceived | | MICReceived = Ciphertext XOR
Keystream
Step 5. Compute MIC as described below given the MessageReceived.
Step 6. If MIC equals MICReceived, then accept MessageReceived as
RSC | | PRUK ID.
```

When calculating a MIC, the following parameters may be used to form the input S to the KDF that is specified in Annex B of TS 33.220:
FC=0xYY.
P0=Message Type.
L0=length of above (i.e. 0x00 0x01).
P1=Message fields that require integrity protection.
L1=length of above.
P2=UTC-based counter.
L2=length of above (i.e. 0x00 0x04).

The input key for MIC computation might be the 256-bit selected key in Step 1, it might also be an integrity key derived as described in previous embodiments. The MIC is set to the x least significant bits of the output of the KDF, e.g., x might be 32 bits. The FC values used in the integrity (and confidentiality) KDF for the DCR message protection must be different than the FC values used for the discovery message protection. The Message Type identifier should identify the exchanged message. For instance, it might be similar to the ProSe PC5 signaling message type in Clause 11.3.1 in TS 24.554. The Message fields (P1) and length (L1) that require integrity protection are at least RSC and PRUK ID but other fields might require integrity protection, e.g., ProSe identifiers, source user info, UE security capabilities, . . . . Parameters exchanged in the DCR message can include PROSE DIRECT LINK ESTABLISHMENT REQUEST message identity, Sequence number, ProSe identifiers,

Source user info, UE security capabilities, UE PC5 unicast signalling security policy, Key establishment information container, Nonce_1, MSB of KNRP-sess ID, Target user info, KNRP ID, Relay service code.

When calculating the message-specific confidentiality keystream, the following parameters may be used to form the input S to the KDF
FC=0xXX
P0=UTC-based counter
L0=length of above (i.e., 0x00 0x04).
P1=RSC
L1=length of above.

The input key may be the 256-bit selected key in Step 1. The message-specific confidentiality keystream is set to the L least significant bits of the output of the KDF, where L is the length of the fields that require protection (RSC and PRUK ID, as above) and MIC. Clause 10.3.1.1 in TS 24.554 that describes the PROSE DIRECT LINK ESTABLISHMENT REQUEST and requires the exchange of several fields that might require protection such as, e.g., the user info—in addition to PRUK ID and RSC. If the length of the fields is longer than 32 bytes, the encryption can rely on a keystream that requires multiple calls to the KDF. This can be done by including a counter as an additional input in the definition of the S bitstring and increasing the counter to generate additional bytes for the Keystream.

We note that in certain cases, the RSC might not be available. For instance, if the technique is applied to non UE to Network relay use cases. In those cases, the computation of the Keystream in above procedure cannot use the RSC as an input parameter in S. In this case, this field might be omitted, i.e., Keystream=KDFDCR_Confidentiality (K, UTC-based counter). Alternatively, the RSC might be replaced by other input parameters that identify, e.g., the type of discovered application.

We note that step 1 in above procedure 1 shows how to determine which key/algorithm to use when remote UE and relay UE have been configured with both the DUCK and the DUSK.

We note that above procedure shows how to apply the same confidentiality approach independently of which key has been configured during discovery. Having slightly different flavors increases the code complexity and in contrast to the protection of the discovery messages—in which having different routines for confidentiality and scrambling allows fulfilling different application needs—is not required in the case of protection of the DCR message fields.

We note that above procedure uses a MIC to check the integrity of the exchanged message. If checking the integrity with a MIC is not required, a simplified version is as follows where only the integrity of the RSC is checked:

The Remote UE does the following:

```
    Step 1. If DUCK available, set DUCK as key K. If DUCK is not
available, then choose DUSK as K. If neither DUCK nor DUSK are
available, the DCR message is not protected, and Steps 2-5 can be
skipped.
    Step 2. Form Message = RSC | | PRUK ID
    Step 3. Calculate Keystream = KDFDCR_Confidentiality (K,
UTC-based counter, RSC) as described above.
  Step 4. Ciphertext = Message XOR Keystream
```

The UE-to-network relay does the following to retrieve the protected fields of the received DCR message, e.g., RSC and PRUK ID:

```
    Step 1. If DUCK available, set DUCK as key K. If DUCK is not
available, then choose DUSK as K. If neither DUCK nor DUSK are
available, the DCR message is not protected, and Steps 2-6 can be
skipped.
    Step 2. Form Ciphertext = a part of protected (RSC | | PRUK ID) in
    the received DCR message.
    Step 3. Calculate Keystream = KDFDCR_Confidentiality (K,
UTC-based counter, RSC) as described above.
    Step 4. Obtain (RSC_Received | | PRUK ID_Received) = Message
Received = Ciphertext XOR Keystream
  Step 5. If RSC_Received equals RSC in Step 3, then accept
  MessageReceived as RSC | | PRUK ID.
```

We note that in above algorithms the Keystream might be generated by means of a NEA algorithm and the MIC might be generated by means of a NIA algorithm.

In particular, the NEA and NIA algorithms used to protect the DCR message might have been:
agreed during discovery, or
preconfigured during the configuration of the UE, during configuration of discovery parameters, or
indicated in the DCR message itself.

The NEA algorithm might be configured by having as the input key in the NEA algorithm the 128 bits of the DUCK (or DUSK) if a 128-NEA algorithm is used. The 32-bit count in the NEA algorithm can be set to the UTC based counter and the BEARER can be set to a predefined binary value, e.g., BEARER=0000, and DIRECTION can be set to a predefined value, e.g., DIRECTION=0. To ensure that the key stream is different than the key stream used for the protection of discovery messages, in particular, the protection of discovery messages with metadata that might rely on NEA algorithms as well, some of the above parameters might require a different configuration, for instance, a first BEARER value should be used when the key is used for the protection of the discovery messages and a second different BEARER value should be used when the key is used for the protection of the DCR message.

Alternatively, the key in the NEA algorithm might be generated by applying a KDF to the chosen key K in Step 1 in the procedures above and using a different FC value for the protection of the discovery messages and DCR message. This ensures that two different keys are used when protecting the DCR messages and when protecting the discovery messages. The KDF might also have as additional inputs the UTC based counter or other unprotected fields in the DCR message.

The NIA algorithm might be configured in a similar way. A different FC value is required as well if a different integrity key is derived by means of a KDF.

We note that the above procedure might not only be applied to improve the security during PC5 link setup in UE to Network relay, but also in other types of PC5 setup. For instance, in UE to UE relay, or UE to UE.

For instance, regarding the establishment of a (secure) PC5 communication link in a UE-to-UE relay scenario, upon discovery, a UE, e.g., the source UE sends a direct communication request (DCR) message including certain parameters, such as an RSC or the PRUK ID or a first nonce used for a subsequent key derivation. This information might be exchanged in the clear unless a solution as in one of above embodiments is applied. This procedure and need is further illustrated by means of a source UE 420 that wants to establish a secure communication link with a target UE 430 over a UE-to-UE relay 410. The CN or one or more network functions in the CN 400 perform configuration. In a first Step, the Remote UEs (Source and Target UEs) and the UE-to-UE relay get the discovery parameters and Prose Key management function (PKMF) address from the 5G DDNMF and the discovery security material from the PKMF respectively. Furthermore, the Remote UEs can be provisioned with the security materials for end-to-end security setup by the PKMF. For example, the security materials for end-to-end security setup include the Prose Service Code (PSC) and associated key. In a subsequent step, the remote UE 420 performs the discovery procedure and PC5 unicast link setup procedure with the UE-to-UE relay 410 by (i) discovering a U2U relay; (ii) sending a Direct Communication Request that includes Relay Service Code (RSC), PRUK ID, and Nonce1; (iii) performing authentication and key agreement between the remote UE 420 and UE-2-UE relay 410 and as result of successful authentication, a key KNRP is derived. Later, the UE-2-UE relay 410 generates Nonce2 and derives KNRP-SESS using KNRP, Nonce1 and Nonce2. The UE-2-UE relay 410 sends a Direct Security Mode Command that contains Nonce 2 to the Remote UE 420. The Direct Security Mode Command is integrity protected based on KNRP-SESS. Then, the Remote UE 410 derives KNRP-SESS using KNRP, Nonce1 and Nonce2 and checks the integrity of the Direct Security Mode Command. If the verification is successful, the Remote UE 420 sends a Direct Security Mode Complete to the UE-2-UE relay 410. To protect certain privacy sensitive fields, or all fields in a DCR message exchange during UE-to-UE relay, e.g., as detailed in above exemplary procedure, one of the keys in the discovery parameters needs to be selected by the sending device and the receiving device, e.g.:
if the DUCK available, the DUCK is to be used to protect those privacy sensitive fields, and
if the DUCK is not available AND the DUSK is available, then the DUSK is to be used to protect those, and otherwise,
if neither DUCK nor DUSK are available, then privacy sensitive fields, or all fields in the DCR message must not be protected.

Once (and if) a key is selected, the sending device can protect the DCR message and transmit the protected DCR message. Once (and if) a key is selected, the receiving device can receive the protected DCR message and securely process it (decrypt/integrity verify). It is to be noted that if the source UE and the target UE have a set of common discovery keys unknown to the relay, then this set of keys might be preferred.

### Improving Security Routines for Discovery Messages in TS 33.303

In a set of embodiments that improves the security routines for discovery messages in TS 33.303: Approach 1, the logic to obtain the key stream (KS) used for encryption is modified according to one of the following options.

In a first Option 1, compute KCM=(EBM XOR 0xFF..FF) where 0xFF..FF is 27 octets long. Note that EBM XOR 0xFF..FF=BITWISENOT (EBM)=KCM. Then calculate KS=KDF (DUCK, UTC-based counter, (KCM AND (Message∥MIC))) where KS is the last 27 octets of the KDF output. Here, EBM is the encryption_bit_mask, KCM is the key_calc_mask, and KS is the keystream. Still, a problem in this option is that the content of the MIC is ignored in the computation of the KS since the MIC is ANDed with the KCM, and the 4 last bytes of the KCM are set to 0 since the EBM is now all 1s the last 4 bytes.

In a second Option 2 building on Option 1, the KCM is given directly, i.e., EBM is not required anymore. This option has the same problem as in Option 1.

In a third Option 3 that addresses in the problem in Option 1 and Option 2, calculate KS=KDF (DUCK, UTC-based counter, EBM, Message∥MIC). Still, a problem with this approach is that the total input size to the KDF is 32+4+27+27 bytes, i.e., more than 2*32 bytes so that the KDF computation requires more CPU resources.

In a fourth Option 4, calculate KS as KDF (DUCK, UTC-based counter, EBM, MIC). In this approach, the MIC is used as fingerprint of the message that is sent. The EBM is included in the KS computation. With this, both the encryption mask as well as the message contents themselves determine the KS. The total message length is less that 2*32 bytes so that the CPU needs do not get worse compared with the current situation. It is to be noted that EBM might not be required if EMB is known/fixed.

The procedure for sending a message can then be modified as:
Step 1: Compute MIC from message and DUIK. MIC is computed, e.g., as in TS 33.303.
Step 2: Append MIC to the message to send: M=M∥MIC
Step 3: Compute KS as described above.
Step 4: Create ciphertext as C=M XOR (KS AND EBM).
Step 5: Apply scrambling on C

The above implies that the EBM also covers the MIC so that the MIC can be encrypted. This is something that TS 33.303 does not allow.

Note that the EBM is preferred to be 0xFF..FF (27 octets), i.e., all bits are encrypted. In this case, the DUSK is just not required. This firstly improves privacy since the device cannot be tracked by monitoring the Encrypted_bits_mask, usage or not of integrity protection ((MIC) cannot be inferred). This also improves performance since a single call to the KDF is required for protecting the confidentiality of the message. In this case, this pseudorandom sequence is computed, e.g., as KS=KDF (DUCK, UTC-based counter, EBM, MIC) and step 4 to compute the ciphertext is just C=M XOR KS. Step 5 is not required.

In an embodiments that improves the security routines for discovery messages in TS 33.303, the scrambling sequence is computed using a UTC-based counter that changes more frequently than once every 16 seconds. For instance, every 8 seconds, every 4 seconds, every 2 seconds, every second. This limits the amount of information leaked by the different periodicities of the UTC-based counters used in scrambling and in confidentiality/integrity.

In an embodiment that improves the security routines for discovery messages in TS 33.303, instead of appending a MIC equal to 0x00000000 when no integrity is applied, e.g., when DUIK is not present, a random looking value should be added. This random looking value can be generated by means of a pseudorandom function from an initial random value. This ensures that an attacker cannot determine whether a UE is using integrity protection or not by observing the broadcasted discovery messages.

In a set of embodiments that improves the security routines for discovery messages.

In TS 33.303, EBM is 27 bytes long, instead of only 23 bytes long. Then, it is possible to calculate KS as in TS 33.303 but KCM is computed as (EBM [0:23] XOR 0xFF..FF)∥0xFFFFFFFF. Here, EBM [0:23] indicates that only the first 23 bytes of EBM are used when XORing with 0xFF..FF that is also 23 bytes long. KS has an output length 4 bytes longer than in TS 33.303, i.e., 27 bytes long, so that it is also feasible to encrypt the MIC.

The procedure for sending a message is then modified as:
Step 1: Compute MIC from message and DUIK. MIC is computed, e.g., as in TS 33.303.
Step 2: Append MIC to the message to send: M=M∥MIC
Step 3: Compute KS as described above.
Step 4: Create ciphertext as C=M XOR (KS AND (EBM∥0xFFFFFFFF)).
Step 5: Apply scrambling on C

Note that in Step 4 EBM is 23 bytes long as in TS 33.303 and 0xFFFFFFFF is appended to it to also encrypt the MIC. Note that Step 3 can be executed before Step 2.

In an exemplary embodiment variant based on the previous proposal, it can be suggested, that the FC value used to generate the pseudo-random scrambling sequence when protecting PRUK ID and RSC in the DCR message may be different that the FC value used to generate pseudo-random scrambling sequence protecting the discovery message. This allows to prevent that two different plaintextted messages could be protected (XOR scrambled) by the same pseudo-random scrambling sequence. The same applies to the usage of FC value used in the encryption algorithm, although this is less critical in this case since other input parameters in the KDF are different, in particular, the message length is different.

### Improving Security Routines To Protect Long Discovery Messages In TS 33.303

In the above embodiments, it is described how a DCR message can be confidentiality protected even if the length of the fields that require protection is longer than 32 bytes, the output size of the used KDF. This is done by encrypting (or scrambling) the message by means of a keystream obtained from multiple calls to the KDF instead of from a single KDF call. This can be done by including at least one counter (a block counter) as an additional input in the definition of the S bitstring used as input in the KDF and increasing the counter to generate additional bytes for the Keystream. Note that instead of a counter, a nonce might be used where a nonce a number randomly generated and used once. For instance, if a message has a length of N*B bytes and B is the output size of the KDF, then N calls to the KDF are required each with a different counter value, e.g., ranging e.g., from 0 to N−1. Such a solution is also applicable to discovery messages that might have a length of more than 32 bytes. In particular, in Rel-17 U2N sidelink relay, RLC UM mode might be used for sidelink discovery messages, and the maximum size of the discovery message could be, e.g., 9000 bytes. Note that as described above, security routines to protect the discovery messages only work for small fixed-size discovery messages. Discovery messages of a bigger size might be caused due to the exchanged of new fields or application layer metadata information. RLC fragmentation might already occur at 2976 bits=372 bytes. In this case, the discovery message can be longer than 32 bytes and multiple calls to the KDF are required. In this case, the discovery message size can be longer than 2976 bits and multiple fragments might occur. Thus, using a KDF for encryption (by means of the DUCK) and/or scrambling (by means of the DUSK) at PDCP layer would require including an additional counter, the block counter, to obtain the pseudorandom sequences from the KDF and DUCK or DUSK. If the protection is done at PDCP layer and a discovery message is 128 bytes long, to obtain the keystream to encrypt the discovery message a total of 4 calls to the KDF are required with counter values as below:

| Call to | Block | The output of the KDF is used to encrypt/ |
|---|---|---|
| the KDF | ounter | scramble bytes of discovery message |
| 1 | 0000 | 0-31 |
| 2 | 0001 | 32-63 |
| 3 | 0002 | 64-95 |
| 4 | 0003 | 96-127 |

If the protection is done at the RLC layer, then it would require including, e.g., two additional input counters to obtain the pseudorandom sequences from the KDF and DUCK or DUSK. The first input counter is a fragment counter C_F and the second input counter is a block counter C_b. The fragment counter identifies a fragment in the overall discovery message. The block counter identifies a block of b (e.g., b=32 bytes) in a fragment. For instance, if fragments are 64 bytes long and the discovery message is 128 bytes long, and the KDF has an output of 32 bytes, there will be 2 64-byte fragments of the discovery message in the air. The fragments of the discovery message will contain the fragment counter. Each fragment contains two blocks of 32 bytes that can be (implicitly) linked to the block counter. In this example, the fragment counter values and block counter values can be “0000” and “0001”, where we assume an hexadecimal representation and two bytes long counters. If the protection is done at RLC layer, to obtain the keystream to encrypt the discovery message a total of 2×2 calls to the KDF are required with counter values as below:

| | | | The output of the KDF is |
|---|---|---|---|
| Call to | Fragment | Block | used to encrypt/scramble |
| the KDF | counter | counter | bytes of discovery message |
| 1 | 0000 | 0000 | 0-31 |
| 2 | 0000 | 0001 | 32-63 |
| 3 | 0001 | 0000 | 64-95 |
| 4 | 0001 | 0001 | 96-127 |

In this last case, we note that both counters can be combined into a single value as:
Fragment_counter*Maximum_number_blocks_in_a_fragment+block_counter

Given the above counter, or counters, the input to the KDFs needs to be modified compared with TS 33.303.

When the DUSK is used, the call to the KDF should contain information from at least a counter, e.g., be as follows:
time-hash-bitsequence=KDF (DUSK, UTC-based counter, block counter)
or
time-hash-bitsequence=KDF (DUSK, UTC-based counter, fragment counter, block counter)

Above, we note that the UE might obtain the fragment counter directly from the received message, i.e., each fragment should contain the fragment counter and this value should not be scrambled. The block counter should start at a predefined value and, e.g., increase by 1, for every additional call to the KDF.

Note that if the fragment counter and/or block counter are not used as input to generate the time-hash-bitsequence, then multiple blocks would be scrambled with the same time-hash-bitsequence. Thus, if two scrambled blocks are XORed together, it is possible to obtained the XOR of the plaintext blocks.

When the DUCK is used, the call to the KDF might be as follows, i.e., including information from at least a counter:
Keystream=KDF (DUCK, UTC-based counter, block counter, (Key_calc_mask AND (Message∥MIC))).

Above, we note that the information about the fragment counter might be included in the message itself.

Fragmentation might also have implications on how integrity protection is done: first, a MIC per discovery message might be required to make sure that an attacker cannot mixed fragments of different discovery messages together. This overall MIC should be included at least in one of the fragments of the discovery message, e.g., in the last fragment. This MIC might be computed as in 6.1.3.4.3.4 in TS 33.303 where the bitstring S might also include the number of fragments in the message and the P1 field refers to the content of the whole message, or, a value that depends on all the contents of the message, e.g., its hash or concatenation of hashes/MICs of parts of the message. Such a MIC can be obtained if the discovery message is protected at PDCP layer. Second, a MIC per fragment can still be required to make sure that fragments are not modified and they can be processed as they arrived. The computation of this MIC should only consider in the input information from the fragment it belongs to, i.e., as in 6.1.3.4.3.4 in TS 33.303 where the bitstring S also includes the fragment counter and the P1 field refers to the content of the fragment only.

Overall, the process in Clause 6.1.3.4.3.2 in TS 33.303 needs to be updated considering that the 5G discovery messages are longer than in LTE. In particular, Steps 3 and 5 require encrypting and scrambling the discovery message with a pseudorandom sequence that is obtained by calling the KDF at least once, but likely more than once and using as one of the inputs to the KDF a block counter, e.g., an increasing block counter, whose value is different in each of the calls to the KDF. The number of calls to the KDF to protect a discovery message is CEIL (message_length/KDF_output size). This approach is applicable to a 5G operation, such as specified for example in TS 33.503. CEIL refers to a ceiling function but can also refer to a quantization function (which can use a quantization step >1).

In case that some fields (e.g., metadata) in the discovery messages do not need to be security protected, or that the security protection of some fields is up to the application, then only a part of the discovery message needs to be protected based on TS 33.303 or as in above embodiments. In an option, all the contents of the discovery message might be fully integrity protected including not only existing fields such as Source Layer-2 ID, Destination Layer-2 ID, Relay Service Code, Announcer Info, or Additional parameters such as NCGI or TAI but also the metadata. This is feasible since the whole message can be passed to the MIC generation procedure in Clause 6.1.3.4.3.2 in TS 33.303. However, only certain fields might be confidentiality protected. In particular, those fields requiring encryption might be less than 32 bytes long so that a single call to the KDF is required. The main difference is that in line 3 in Clause 6.1.3.4.3.2, confidentiality is added to only a part of the message and the fields that require confidentiality protection have to be within 32 consecutive bytes.

An alternative embodiment to the usage of a key derivation function to obtain a pseudorandom sequence that is longer than 32 bytes long is to apply one of the standard 5G confidentiality (e.g., 128-NEA1, 128-NEA2, 128-NEA3) and integrity (e.g., 128-NIA1, 128-NIA2, 128-NIA3) algorithms—described in of TS 33.401—in the protection of the discovery messages.

A key requirement to do this is that the sending device (e.g., an announcing UE) includes a field in the discovery message that indicates the security algorithm used to encrypt and/or integrity protect the contents of the discovery message. This allows the receiving UE (e.g., a monitoring UE) to select the right algorithm used to decrypt/integrity verify the received message. In discovery model B, the algorithms supported by the sending UE might be included in the first message. Upon reception of the message, the receiving UE can use the received supported algorithms to decide the encryption and/or integrity algorithm used to protect the response. In the response, the selected algorithm can be included so that the receiving UE can decrypt/integrity verify it. The field including the supported algorithms should not be encrypted since if it is encrypted, the receiving party does not know which algorithms it is supposed to use.

Alternatively, if multiple encryption and/or integrity algorithms might be supported and used by a sending UE and no field is added to the discovery message to identify which specific encryption and/or integrity algorithms are used, then the sending UE (e.g., an announcing UE) will select suitable encryption and/or integrity algorithms and encrypt and/or integrity protect the discovery message, and send the protected discovery message. Upon reception of the protected discovery message, a receiving UE (e.g., a monitoring UE) will proceed to decrypt the message and then to verify the integrity for all combinations of supported encryption and/or integrity algorithms. The receiving UE might first apply a decryption algorithm and then try to check the integrity with all supported integrity algorithms. For instance, the receiving UE first decrypts with 128-NEA1 and then checks integrity with 128-NIA1, 128-NIA2 and 128-NIA3. Once it is done, the UE decrypts with 128-NEA2 and then checks integrity with 128-NIA1, 128-NIA2 and 128-NIA3, etc. The receiving UE stops when the MIC verification is successful.

The processing of long discovery messages impacts the message processing in both sending and receiving UEs compared with Clause 6.1.3.4.3.2 and 6.1.3.4.3.3 in TS 33.303.

In such implementation, the UE sending a discovery message can receive the Code-Sending Security Parameters from the ProSe Function (as described in the security flows) to indicate how to protect the message. The Code-Sending Security Parameters may contain a DUSK and may contain a DUIK. The Code-Sending Security Parameters may contain both, a DUCK and an Encrypted_bits_mask. The UE sending a discovery message does the following steps:
1. Form Discovery Message (e.g. add Suffix if only Prefix was allocated).
2. Calculate MIC if a DUIK was provided, otherwise set MIC to all zeros
3. Add message-specific confidentiality to the message if DUCK was received
4. Append MIC to the output of step 3.
5. Add scrambling over the output of step 4 if the DUSK was received.

Or alternatively, to ensure that the MIC is encrypted:
1. Form Discovery Message (e.g. add Suffix if only Prefix was allocated).
2. Calculate MIC if a DUIK was provided, otherwise set MIC to all zeros
3. Append MIC to the output of step 1.
4. Add message-specific confidentiality to the message if DUCK was received
5. Add scrambling over the output of step 4 if the DUSK was received.

In Step 1, a key difference compared with TS 33.303 is that the message length is not fixed. Thus it may be required to include a field in the message indicating the message length or indicating whether application specific fields are included whose length is application dependent.

An option to realize this is to always include a message length in all discovery messages that corresponds to the sum of the fixed (always present) fields of the discovery message and optional fields. For instance, if a message contains fixed fields RSC, and ProSe Relay UE ID, and Announcer Info of lengths 24 bits, 24 bits, and 48 bits as well as metadata of length 256 bits, then there is a field indicating a total length of 42 bytes. Another option is to include a bitmask indicating the presence of optional fields after the fixed (always present) fields. For instance, if there are x optional fields, an x bits mask can be included to indicate their presence. For instance, if a mask with value 1000 is present, then the first bit equal to 1 indicates the presence of a first optional field out of four possible optional fields. Thus, the receiving device knows that there is an additional field, e.g., with metadata. This optional fields might be after the fixed fields. The first bytes of each optional field, e.g., a metadata field, need to include in this case the length, e.g., 32 bytes as in the example above. Another key difference in Steps related to message-specific confidentiality and scrambling is that the protection of the discovery message requires more than a single call to the KDF.

As for the processing at the receiving UE, the Code-Receiving Security Parameters received from the ProSe Function (as described in the security flows) are used to indicate to a UE how a received discovery message is protected. The Code-Receiving Security Parameters may contain a DUSK, may contain either a DUIK or an indication whether to use Match Reports for MIC checking. The Match Reports option is generally not allowed for ProSe Query Codes. The Code-Receiving Security Parameters may also contain both a DUCK and a corresponding Encrypted_bits_mask.

The UE receiving a Discovery Message may thus perform the following steps:
1. Undo scrambling (as in step 5 of sending UE) if a DUSK was received.

Note that if the total message length is included, then a UE can use this input value to allocate buffers required for, e.g., computing the MIC or determining how long the scrambling/encryption pseudorandom sequences are. The length value can be obtained—if the length field is present—after undoing scrambling in the first part of the message. If the message length is not directly available, the length of the input for the MIC computation or the required length for scrambling is computed step wise by accessing the different optional fields, and retrieving from each of them the length of each individual field.
2. Check for match on the bits of the message that are not encrypted using message specific confidentiality. If no match, then abort.

Note that some bits that the discovery filter indicates to be matched, may be encrypted by message-specific confidentiality at this stage. The UE can look for a match on the other bits after this step to minimise the amount of processing performed before finding a match.

Note that the match might only be required in the first part of the message (e.g., the first 32 bytes of the message) so that a single call to the KDF is required. If a match is found, the receiving UE can read the length of the discovery message (if the length field is available) and unscramble the rest of the message. Alternatively, the receiving UE can check in the mask for the presence of additional optional fields, e.g., a metadata field. The receiving UE will then unscramble the first bytes of the optional fields to retrieve the field length and then proceed to unscramble it.
3. Undo message-specific confidentiality if a DUCK was received (as in step 3 of sending UE)
4. Check for full match if only a match on non-encrypted bits was found in 3. If no match then abort
5. If a MIC check is required, check MIC directly (if a DUIK was given in the Discovery Filter Security Parameters) or via Match Report if indicated in the Discovery Filter Security Parameters.

The integrity protection is similar to Clause 6.1.3.4.3.4 in TS 33.303:

The sending UE can thus perform the following
1. Compute output bitsequence from DUIK, Message, and UTC-based counter passed through a MIC calculation function in Annex A.2 in TS 33.303.
2. Take the n bytes, e.g., n=4, of the output of the function and set that as the value of the MIC for this Message.

The receiving UE or ProSe Function would do the exact same steps but also make a comparison between the computed MIC and the received MIC.

The scrambling protection is similar to Clause 6.1.3.4.3.5 in TS 33.303 although with certain changes to account for the longer messages.

In such example, the sending UE does the following:
1. Set the 4 LSBs of the UTC-based counter equal zero, for the purpose of this scrambling calculation only.
2. Compute the time-hash-bitsequence from DUSK and the UTC-based counter (modified as in step 1), passed through a keyed hash function as follows:
   a. time-hash-bitsequence=″″
   b. For i=a to (a+FLOOR((L+4)/32)):
      time-hash-bitsequence=time-hash-bitsequence∥KDF (DUSK, UTC-based counter, i)
   c. time-hash-bitsequence=time-hash-bitsequence∥ LSB (KDF (DUSK, UTC-based counter, i), 8*(L+4−32*FLOOR((L+4)/32)))
3. XOR the time-hash-bitsequence with the entire Discovery Message (including MIC) being processed.

The receiving UE can also do the exact same steps except applied to the received message being processed. Above, the value “a” might be any initial index value and LSB means Least Significant Bits. FLOOR(x) returns the largest integer less than or equal to x.

In this embodiment, the message-specific confidentiality protection is similar to Clause 6.1.3.4.3.6 in TS 33.303 although with certain changes to account for the longer messages.

The sending UE does the following:
1. Compute Key_calc_mask=(Encrypted_bits_mask XOR 0xFF..FF)∥0xFFFFFFFF
2. Obtain Keystream by means of a KDF as follows
   a. Keystream=″″
   b. H=(Key_calc_mask AND (Message∥MIC)) or alternatively Hash ((Key_calc_mask AND (Message∥MIC)))
   c. For i=a to (a+FLOOR (L/32)):
      i. Keystream=Keystream∥ KDF (DUCK, UTC-based counter, i, H).
   d. Keystream=Keystream∥ LSB (KDF (DUCK, UTC-based counter, i, H), 8*(L−32*FLOOR (L/32)))
3. XOR (Keystream AND Encrypted_bits_mask) into the Message.

The receiving UE does the corresponding same steps applied to the received Discovery Message being processed.

Above, in step 2.b., H can refer to either (Key_calc_mask AND (Message∥MIC)) or a function of this value, e.g., its hash, or a function of part of its inputs, e.g., hash (Key_calc_mask| MIC). The main purpose is to compress a potentially long message into a shorter fingerprint that can be used in each of the KDF calls in step 2.c.i increasing efficiency.

The above algorithms are complemented by changes in the definition of the inputs to the KDF used to generate Keystream and time-hash-bitsequence. These changes are required in the definitions present in Appendix A.5 and A.6 in TS 33.303.

In the calculation of the scrambling bit sequence for discovery (related to A.5 in TS 33.303), the following parameters shall be used to form the input S to each of the calls to the KDF that is specified in Annex B of TS 33.220:
FC=a unique identifier.
P0=UTC-based counter for scrambling associated with the discovery slot-see subclause 6.1.3.4.3.5.
L0=length of above (i.e. 0x00 0x04).
P1=message fragment index.
1 L1=length of the above (i.e., 0x00 0x02).

The input key shall be the 256-bit DUSK.

L1 is 2 bytes long since this is the minimum byte length required to protect up to 9000 bytes. P1 refers to a fragment or block of 32 bytes in the discovery message. The value 32 is used since a 32 bit KDF output is assumed as in the case of TS 33.220. If a different KDF is used, then the length is to be adapted.

For a discovery message of length L, a total of CEIL ((L+LMIC)/32) calls to the KDF are required, each with a different P1 value. Here, L+LMIC is used where L refers to the length of the discovery message and LMIC refers to the length of the MIC that is scrambled. CEIL(x) returns the smallest integer greater or equal to x.

The scrambling bit sequence is set to the concatenation of the whole KDF outputs of the first FLOOR((L+LMIC)/32) KDF calls and the R=8 (L+LMIC−32*FLOOR((L+LMIC)/32)) least significant bits of the output of the last KDF calls. Instead of the LSBs, any subset of R bits could also be chosen. FLOOR(x) returns the largest integer less than or equal to x.

When calculating the message-specific confidentiality keystream for discovery (related to A.6 in TS 33.303), the following parameters shall be used to form the input S to each of the calls to the KDF that is specified in Annex B of TS 33.220 [5]:
FC=0x4D
P0=UTC-based counter associated with the discovery slot-see subclause 6.1.3.4.3.6.
L0=length of above (i.e. 0x00 0x04).
P1=message fragment index.
L1=length of the above (i.e., 0x00 0x02).
P2=(Key_calc_mask AND (Message∥MIC))—see subclause 6.1.3.4.3.6
L2=length of above (i.e. 0x00 0x1B).

The input key shall be the 256-bit DUCK.

For a discovery message of length L, a total of CEIL (L/32) calls to the KDF are required each with a different P1 value. Note that LMIC should also be included if the MIC needs to be encrypted. CEIL(x) returns the smallest integer greater or equal to x.

The message-specific confidentiality keystream is set to the concatenation of the KDF outputs of the first FLOOR (L/32) KDF calls and the R=8 (L−32*FLOOR (L/32)) least significant bits of the output of the last KDF calls. Instead of the R LSBs, it can also be any subset of R bits. FLOOR(x) returns the largest integer less than or equal to x.

An additional potential modification refers to the usage of an NEA algorithm instead of the KDF when encrypting and/or scrambling:

This can be useful when encrypting since the keystream sequence need to be generated more frequently (because of the way the UTC-based counter is computed).

This can be useful when scrambling when encryption is done only to a minor part of the message, e.g., only the last bytes of the discovery message.

In this case, the input key in the NEA algorithm can be the 128 LSBs of the DUCK (or DUSK) if a 128-NEA algorithm is used. The 32-bit count in the NEA algorithm can be set to the UTC based counter and the BEARER can be set to a predefined binary value, e.g., BEARER=0000, and DIRECTION can be set to a predefined value, e.g., DIRECTION=0 if it is a Model A discovery message or the first Model B discovery message or DIRECTION=1 for the second discovery message in Model B. The length field should contain the length of the (part of the) discovery message that requires integrity protection.

An additional potential modification refers to the usage of an NIA algorithm instead of a KDF-based MIC approach. In this case, the input key in the NIA algorithm can be the 128 LSBs of the

| | |
|---|---|
| 1 | Form Discovery Message (e.g. add Suffix if only Prefix was |
| | allocated). |
| 2 | Calculate MIC if a DUIK was provided, otherwise set MIC to all |
| | zeros |
| 3 | Append MIC to the output of step 1. |
| 4 | Obtain Ciphertext as follows |
| 5 | Ciphertext = “” |
| 6 | H = Hash((Key_calc_mask AND (Message \| \| MIC))) |
| 7 | For i = a to (a + FLOOR((L+4)/32)): |
| 8 | CT = Message[i-a] XOR |
| | (KDF (DUCK, UTC-based counter, i, H) AND |
| | Encrypted_bits_mask[i]) XOR |
| | KDF (DUSK, UTC-based counter, i, H) |
| 9 | Ciphertext = Ciphertext \| \| CT |
| 10 | n = CEIL( (L+4)/32 ) |
| 11 | bLSB = 8( L + 4 − 32*FLOOR((L+4)/32) ) |
| 12 | CT = Message[n] XOR |
| | LSB((KDF (DUCK, UTC-based counter, n, H) AND |
| | Encrypted_bits_mask[n]), bLSB) XOR |
| | LSB(KDF (DUSK, UTC-based counter, n, H), bLSB) |

DUIK if a 128-NIA algorithm is used. The 32-bit count in the NIA algorithm can be set to the UTC based counter and the BEARER can be set to a predefined binary value, e.g., BEARER=0000, and DIRECTION can be set to a predefined value, e.g., DIRECTION=0 if it is a Model A discovery message or the first Model B discovery message or DIRECTION=1 for the second discovery message in Model B. The length field should contain the length of the (part of the) discovery message that requires integrity protection.

An additional potential modification refers to parallel processing of encryption and scrambling. In this case, the underlying algorithm in Section 6.1.3.4.3.2 in TS 33.303 and included above is realized as follows:

In above algorithm, H in line 6 is sent to the hash of (Key_calc_mask AND (Message∥MIC))) for performance purposes as already discussed above. The CT in line 8 is computed in fragments of 32 bytes performing the encryption and scrambling at the same time. This is useful in computer architectures having Single Instruction on Multiple pieces of Data (SIMD) instructions such as AVX2. In the algorithm above, the MIC is also encrypted. Encrypting also the MIC has the advantage of having an identical loop length for both encryption and scrambling. In the algorithm above, line 12 computes the encryption/scrambling of the last bytes (<32) of the messages.

In another additional potential modification, the bulk part of the discovery message is not encrypted, e.g., optional fields such as metadata are not encrypted since this is left to the application layer. However, the whole discovery message is scrambled to avoid tracking. In the below algorithm, the optional fields are located before fixed fields.

| | |
|---|---|
| 1 | Form Discovery Message (e.g. add Suffix if only Prefix was |
| | allocated). |
| 2 | Calculate MIC if a DUIK was provided from the whole message, |
| | otherwise set MIC to all zeros |
| 3 | Append MIC to the output of step 1. |
| 4 | Obtain Ciphertext as follows |
| 5 | Ciphertext = “” |
| 6 | H = Hash((Key_calc_mask AND (Message \|\| MIC))) |
| 7 | Ciphertext = “” |
| 8 | For i= a to (a + FLOOR((L+4)/32)): |
| 9 | CTS = CT[i-a] XOR KDF (DUSK, UTC-based counter, i) |
| | Ciphertext = Ciphertext \|\| CTS |
| 10 | n= CEIL( (L+4)/32 ) |
| 11 | Ciphertext = Message[n] XOR |
| | LSB((KDF (DUCK, UTC-based counter, n, H) AND |
| | Encrypted_bits_mask[n]), bLSB) XOR |
| | LSB(KDF (DUSK, UTC-based counter, n, H), bLSB) |

In another additional potential modification similar to the one above, only a part of the discovery message, e.g., the fixed fields, is integrity/encrypted protected and the whole discovery message is scrambled. The main reason is that the security in some fields in the discovery message might be left to the application (e.g., metadata) but still the security functionality should make sure that UEs sending discovery messages cannot be tracked.

In another additional potential modification, the protection of the discovery message is first applied to the first part of the message, e.g., the first 32 bytes, and then to the remaining—or second-part of the message. The goal here is to keep the size of the fixed fields (located in the first part of the message) that are scrambled/encrypted/integrity protected by the discovery security routines as short as possible, e.g., under or up to 32 bytes long so that the processing of discovery message fields such as Source Layer-2 ID, Destination Layer-2 ID, Relay Service Code, Announcer Info, or Additional parameters can still be done by means of a single KDF call as efficiently as possible. Another reason relates to the fact that if the message length is long, e.g., close to 9000 bytes, an attacker might modify real short discovery messages to indicate a long message length.

An attacker can modify the length by flipping certain bits of the length field. The attacker can do this because scrambling is done by XORing. This can cause a receiving UEs to spend too much energy descrambling, decrypting, and finally checking the MIC associated to the whole discovery message. This can facilitate, e.g., a Denial of Service Attack. Thus, an alternative consists in processing (descrambling, decrypting, and integrity checking) in an initial step the first part (e.g., the first 32 bytes) of the discovery message only. If the MIC verification associated to the first part of the message is sucessful and the first part of the message indicates the presence of a second part (e.g., length field >32 bytes), the receiving UE can proceed to process (descramble, decrypt, integrity check) the rest of the message. Thus, a discovery message might include two MICs: a MIC for the first 32-LMIC bytes (e.g., 28 bytes if the MIC has a length of LMIC=4 bytes) and a second MIC for the remaining bytes of the message. A discovery message might also contain in the first part of the message, e.g, in the first 32 bytes of the message, a (truncated) hash H computed from the remaining part of the message as well as a MIC verifying the integrity of the first part of the message, including verifying the integrity of H. If the verification of the MIC in the first part of the message is successful, the receiving UE can proceed to process the rest of the message. The integrity of the rest of the message is verified by checking that the hash value computed from the rest of the message equals the value H included and in the first part of the message and verified with the MIC included in the first part of the message. Note that H might refer to the (truncated) hash of the second part of the message in its plaintext, encrypted, or scrambled form. In this last case (scrambled form), the receiving UE can compute the truncated hash of the second part of the message when it is still scrambled (i.e., directly after reception), and compare it with the H value that was in the first part of the message. If this is successful, the receiving UE can proceed to undo the scrambling of the second part of the message. The MIC can be computed as in Clause 6.1.3.4.3.4 in TS 33.303.

The processing of a message when sending the discovery message is as follows:
1. Form Discovery Message (e.g. add Suffix if only Prefix was allocated).
2. Calculate a MIC if a DUIK was provided for the first part of the message, otherwise set MIC to all zeros
3. Add message-specific confidentiality to the first part of message if DUCK was received
4. Append MIC to the output of step 3.
5. Add scrambling over the output of step 4 if the DUSK was received.
6. Calculate MIC if a DUIK2 was provided and/or the second part of the message requires integrity protection, otherwise set MIC to all zeros.
7. Add message-specific confidentiality to the second part of message if DUCK2 was received and/or the second part of the message requires confidentiality protection,
8. Append MIC to the output of step 7.
9. Add scrambling over the output of step 8 if the DUSK2 was received and/or the second part of the message requires scrambling protection.

In this algorithm, DUIK2, DUSK2, DUCK2 might correspond to DUIK, DUSK, DUCK or be different keys, e.g., application dependent. Whether the second part requires protection or not might be based on a policy. When creating the message, some steps above can be rearranged, e.g., Step 6 might follow Step 2, Step 7 might follow Step 3, Step 8 might follow Step 4, and Step 9 might follow Step 5. Similarly, Step 6 might be modified to compute the truncated hash H of the second part of (the plaintext) message and perform this computation before Step 2. Then in Step 2, the MIC included in the first part of the message is computed using H as input and including H as a field in the first part of the message. Similarly, Step 9 might be modified to additionally compute the truncated hash H′ from the scrambled version of the second part of message and perform this computation before Step 2. Then in Step 2, the MIC is computed using H′ as input and including H′ as a field in the first part of the message.

When receiving a message, the receiving UE should firstly process the first part of the message, and then process the second part of the message:
1. Descramble the first part of the message if the DUSK was received.
2. Optionally, check for a match. If no match present, abort processing.
3. Decrypt the first part of the message if the DUCK was received.
4. Optionally, check for a full match, if no match, abort processing.
5. Verify MIC of the first part of the message if the DUIK was received. If MIC verification fails, abort processing.
6. If length field >32 present in the first part of the message or mask in the first part of the message indicates further fields, descramble the second part of the message if the DUSK2 was received and/or the second part of the message requires scrambling protection.
7. If length field >32 present in the first part of the message or mask in the first part of the message indicates further fields, decrypt the second part of the message if the DUCK2 was received and/or the second part of the message requires encryption protection.
8. If length field >32 present in the first part of the message or mask in the first part of the message indicates further fields, verify integrity of the second part of the message if the DUIK2 was received and/or the second part of the message requires integrity protection.

As indicated above, integrity protection in the second part of the message might be achieved by means of a MIC included in the second part of the message, or by including in the first part of the message a fingerprint H of the second part of the message that is verified by means of the MIC included in the first part of the message. The encryption/scrambling of the second part of the message is performed by making one or multiple calls to a KDF. The overall encryption/scrambling of the whole message is performed by making more than one call to a KDF. For instance, if the first part of the message includes fingerprint H′ that corresponds to a function, e.g., a truncated hash, of the scrambled second part of the message, then after Step 5, the receiving UE will check whether the hash value obtained from the received scrambled second part of the message matches the received and verified H′ value. If it matches, the receiving UE undoes scrambling (Step 6) and decrypts (step 7). Integrity verification (Step 8) is not strictly required.

Such a processing as described in the last algorithm is suitable since discovery messages might have some fields that are always present and whose length is of limited size for performance purposes. Furthermore, additional (optional) fields might be integrity protected/encrypted by the application. Scrambling, however, might be applied to all fields, e.g., to the whole discovery message to prevent tracking. It might also be required to make sure that such bulky messages have not been modified. For instance, Clause 11.2.5 in TS 24.334 includes the definition of discovery messages, e.g., the PC5 discovery message content for open ProSe direct discovery:

| | | | Length |
|---|---|---|---|
| Information Element | Type/Reference | Presence | (bits) |
| Message Type (NOTE) | Message Type | M | 8 |
| | 12.2.2.10 | | |
| ProSe Application Code | Binary 12.2.2.6 | M | 184 |
| MIC | Binary 12.2.2.11 | M | 32 |
| UTC-based Counter LSB | Binary 12.2.2.22 | M | 8 |

NOTE:
The Discovery Type is set to “Open discovery” and the Content Type is not set to “application-controlled extension enabled”.

Furthermore, it has been proposed that: “depending on UE implementation, the application layer discovery messages are exchanged either as user traffic over PC5 or alternatively as part of metadata in PC5 Direct Discovery message as specified in clause 6.3.2.1. In the latter case, the PC5 Direct Discovery message can contain additional field carrying application layer metadata information, e.g., the Application layer discovery messages for group discovery. The format and contents of this additional field is out of scope of 3GPP. Performance of the PC5 Direct Discovery message including the application layer information will be affected if the resulted PC5 Direct Discovery message size is too big, e.g. longer delay and lower reliability.” If the information is exchanged as part of metadata, the messages might be longer, than e.g., 23 bytes, message size in LTE. Thus, the first, e.g., 23 or 28 bytes (the first part of the discovery message) might be integrity/encrypted protected as shown above and in a similar way as done in LTE and the whole discovery message, including metadata, might be scrambled. The first part of the message might include a truncated hash of the scrambled second part of the message. The first part of the message might be processed (descrambled, decrypted, integrity check) first, then the integrity of the second part of the message might be verified by means of the H value, and finally the second part of the message might be unscrambled.

Note that scrambling (or encrypting) the discovery message by the sending UE and undoing the scrambling (or decrypting) the discovery message by the receiving UE still requires multiple calls to the KDF even if the first part of the message is processed (scrambling, encryption, integrity verification) in a first step and the second part of the message is processed (scrambling, encryption, integrity verification) in a second step. Thus, the generation of the pseudorandom sequences for scrambling/encryption can still be performed as showed previously.

In an alternative embodiment, some (optional) fields such as metadata might be encrypted/integrity protected as determined by the application. However, the discovery message is enhanced to include a new field that can be used to carry the symmetric key used by the application to encrypt/integrity protect the metadata, e.g., a master key used to generate DUIK2, DUSK2, DUCK2. A new field, metadata key, can also be included and similarly protected and if present (e.g., value different than 0x000 . . . 000) it will be used to decrypt/integrity verify other fields such as e.g., metadata.

In an exemplary instantiation of above embodiments, three types of security algorithms are used to protect the discovery messages over the PC5 interface: integrity protection, scrambling protection, and message-specific confidentiality which are defined in clause 6.1.3.4.3 in TS 33.303 [4]. These algorithms are applied with the following modified processing of the scrambling and confidentiality algorithms that extend TS 33.303 [4] to protect discovery messages of variable length: Scrambling protection: Overall process when sending (or receiving)

When a UE sends (or receives) a message, the scrambling (descrambling) is done according to the following steps:
a) Set the 4 LSBs of the UTC-based counter equal zero, for the purpose of this scrambling calculation only.
b) Compute the time-hash-bitsequence from DUSK and the UTC-based counter (modified as in step 1), passed through a keyed hash function as follows:
   a. time-hash-bitsequence=″″
   b. For i=0 to FLOOR((L+LMIC)/32)):
      i. time-hash-bitsequence=time-hash-bitsequence∥ KDF (DUSK, UTC-based counter, i)
   c. time-hash-bitsequence=time-hash-bitsequence∥ LSB (KDF (DUSK, UTC-based counter, FLOOR((L+LMIC)/32))+1), 8*(L+LMIC−32*FLOOR((L+LMIC)/32)))
c) XOR the time-hash-bitsequence with the entire Discovery Message (including MIC) being processed.

Where: L is the length of the discovery message; LMIC is the length of the MIC, e.g., 4 bytes; ∥ indicates concatenation; LSB (x,b) returns the b least significant bits of x; FLOOR(x) returns the largest integer less than or equal to x; CEIL(x) returns the smallest integer greater or equal to x; KDF ( ) refers to a key derivation function as specified next.

When calculating the time-hash-bitsequence for discovery, the following parameters shall be used to form the input S to the KDF that is specified in Annex B of TS 33.220 [5]:
FC=a unique identifier.
P0=UTC-based counter for scrambling associated with the discovery slot-see subclause 6.1.3.4.3.5.
L0=length of above (i.e. 0x00 0x04).
P1=message fragment index.
L1=length of the above (i.e., 0x00 0x02).

The input key shall be the 256-bit DUSK.

L1 is 2 bytes long since this is the minimum byte length required to protect up to 9000 bytes. P1 refers to a fragment or block of 32 bytes in the discovery message.

For a discovery message of length L, a total of CEIL ((L+LMIC)/32) calls to the KDF are required, each with a different P1 value.

The scrambling bit sequence is set to the concatenation of the whole KDF outputs of the first FLOOR((L+LMIC)/32) KDF calls and the R=8 (L+LMIC−32*FLOOR((L+LMIC)/32)) least significant bits of the output of the last KDF call.

Confidentiality protection: Overall process when sending (or receiving)

When a UE sends (or receives) a message, the encryption (decryption) is done according to the following steps:
a) Compute Key_calc_mask=(Encrypted_bits_mask XOR 0xFF..FF)∥0xFFFFFFFF
b) Obtain Keystream by means of a KDF as follows
   a. Keystream=″″
   b. HH=(Key_calc_mask AND (Message∥MIC)) or alternatively HH=Hash ((Key_calc_mask AND (Message∥MIC)))
   c. For i=0 to FLOOR (L/32):
      i. Keystream=Keystream∥ KDF (DUCK, UTC-based counter, i, HH).
   b. Keystream=Keystream∥ LSB (KDF (DUCK, UTC-based counter, FLOOR (L/32)+1, HH), 8*(L−32*FLOOR (L/32)))
a) XOR (Keystream AND Encrypted_bits_mask) into the Message.

Where: L is the length of the discovery message; LMIC is the length of the MIC, e.g., 4 bytes; ∥ indicates concatenation; LSB (x,b) returns the b least significant bits of x; FLOOR(x) returns the largest integer less than or equal to x; CEIL(x) returns the smallest integer greater or equal to x; KDF ( ) refers to a key derivation function as specified next.

When calculating the message-specific confidentiality keystream for discovery, the following parameters shall be used to form the input S to the KDF that is specified in Annex B of TS 33.220 [5]:
FC=a unique identifier
P0=UTC-based counter associated with the discovery slot.
L0=length of above (i.e. 0x00 0x04).
P1=message fragment index.
L1=length of the above (i.e., 0x00 0x02).
P2=HH.
L2=length of HH.

The input key shall be the 256-bit DUCK.

For a discovery message of length L, a total of CEIL (L/32) calls to the KDF are required each with a different P1 value. LMIC should also be included if the MIC needs to be encrypted.

The message-specific confidentiality keystream is set to the concatenation of the KDF outputs of the first FLOOR (L/32) KDF calls and the R=8 (L−32*FLOOR (L/32)) least significant bits of the output of the last KDF call.

In the above solution, the MIC might be encrypted. If the MIC is encrypted, the length should be set to L+LMIC (instead of only L) where LMIC is the length of the MIC.

In an exemplary instantiation of above embodiments, three types of security algorithms are used to protect the discovery messages over the PC5 interface: integrity protection, scrambling protection, and message-specific confidentiality which are defined in clause 6.1.3.4.3 in TS 33.303 [4]. These algorithms are extended to protect the discovery messages by:
processing (integrity protection, confidentiality, scrambling) first the short first part of the discovery message including fixed fields, and if successful,
processing (integrity protection, confidentiality, scrambling) then the long second part of the message including optional fields of variable length such as metadata.

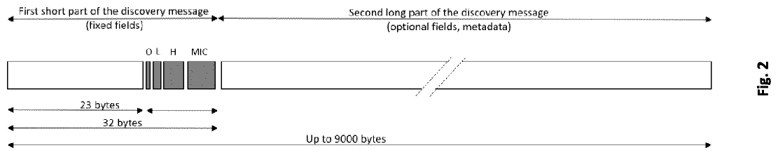

FIG. 2 describes the structure of the discovery message. The short first part includes the fixed fields, e.g., Relay Service Code. These fields include:
a 1-bit long Optional field O that indicates the presence of optional fields in the second part of the message,
a 14-bits long length field L that indicates the length of the optinal fields in the second part of the message,
a 25-bits long truncated hash field H obtained from the second part of the message, and
a 32-bit Message Integrity Code (MIC) computed over the fields in the first part of the message.

A possible instantation is that fields O, L, H have lenghts of 1 bit, 14 bits, and 25 bits, respectively. In total, 40 bits so that the total length of the first part of the message is 32 bytes. These fields might also be implicitly transmitted. For instance, the first 3 bytes of the metadata include the Metadata IE and length.

The processing of a message when sending the discovery message is as follows:
1. Calculate a MIC2 if a DUIK was provided for the second part of the message, otherwise set MIC2 to all zeros.
2. Add message-specific confidentiality to the second part of message if DUCK was received and/or the second part of the message requires confidentiality protection,
3. Append MIC2 to the output of step 3.
4. Add scrambling over the output of step 4 if the DUSK was received.
5. Compute truncated hash H of the second part of the message (output of step 4).
6. Form Discovery Message (e.g. add Suffix if only Prefix was allocated), and append fields O, L, and H.
7. Calculate a MIC1 for the first part of the message (up to H) if a DUIK was provided, otherwise set MIC1 to all zeros.
8. Add message-specific confidentiality to the first part of message if DUCK was received.
9. Append MIC1 to the output of step 8.
10. Add scrambling over the output of step 9 if the DUSK was received.
11. Create complete discovery message by appending output of step 4 to the output of step 10.

The second part of the message includes an independent messagge integrity code MIC2. This might not be always needed since integrity protection of the second part of the message is always enabled by means of the the truncated hash of the second part of the message that is verified by means of the message integrity code MIC1 included in the first part of the discovery message.

Steps 2, 3 and 4 and Steps 7, 8 and 9 follow the same order as in TS 33.303. It is preferred to rearrange them as swap Steps 3-4 and Steps 8-9 so that the MICs are always protected.

The processing when receiving a discovery message is as follows, the receiving UE firstly processes the first part of the message, and then processes the second (optional) part of the message. In particular, the steps to follow are:
1. Descramble the first part of the message if the DUSK was received.
2. Optionally, check for a match. If no match present, abort processing.
3. Decrypt the first part of the message if the DUCK was received.
4. Optionally, check for a full match, if no match, abort processing.
5. Verify MIC1 of the first part of the message if the DUIK was received. If MIC1 verification fails, abort processing.
6. If length field>32 present in the first part of the message or mask in the first part of the message indicates further fields or optional fields,
   a. If the the truncated hash of the scrambled/encrypted/integrity protected second part of the message corresponds to the truncated hash field H included and verify in the first part of the message.
      i. descramble the second part of the message if the DUSK was received.
      ii. decrypt the second part of the message if the DUCK was received.
      iii. verify the integrity of the second part of the message if the DUIK was received.

Step 6.a.iii might not always be required since Step 6.a already performs integrity checking.

The scrambling algorithm used to scramble the (first and second part of the) discovery message is done according to the following steps that extend TS 33.303 [4]:
1. Set the 4 LSBs of the UTC-based counter equal zero, for the purpose of this scrambling calculation only.
2. Compute the time-hash-bitsequence from DUSK and the UTC-based counter (modified as in step 1), passed through a keyed hash function as follows:
   a. time-hash-bitsequence=″″
   b. For i=0 to FLOOR((L+2*LMIC)/32):
      time-hash-bitsequence=time-hash-bitsequence∥ KDF (DUSK, UTC-based counter, i)
   c. time-hash-bitsequence=time-hash-bitsequence∥ LSB (KDF (DUSK, UTC-based counter, FLOOR((L+2*LMIC)/32)+1), 8*(L+2*LMIC−32*FLOOR((L+2*LMIC)/32)))
3. XOR the time-hash-bitsequence with the entire Discovery Message (including MIC) being processed.

Where: L is the length of the discovery message; LMIC is the length of the MIC, e.g., 4 bytes; ∥ indicates concatenation; LSB (x,b) returns the b least significant bits of x; FLOOR(x) returns the largest integer less than or equal to x; CEIL(x) returns the smallest integer greater or equal to x; KDF ( ) refers to a key derivation function as specified next.

When calculating the time-hash-bitsequence for discovery, the following parameters shall be used to form the input S to the KDF that is specified in Annex B of TS 33.220 [5]:
FC=a unique identifier.
P0=UTC-based counter for scrambling associated with the discovery slot.
L0=length of above (i.e. 0x00 0x04).
P1=message fragment index.
L1=length of the above (i.e., 0x00 0x02).

The input key shall be the 256-bit DUSK.

L1 is 2 bytes long since this is the minimum byte length required to protect up to 9000 bytes. P1 refers to a fragment or block of 32 bytes in the discovery message.

For a discovery message of length L, a total of CEIL ((L+2*LMIC)/32) calls to the KDF are required, each with a different P1 value.

The scrambling bit sequence is set to the concatenation of the whole KDF outputs of the first FLOOR((L+2*LMIC)/32) KDF calls and the R=8 (L+2*LMIC−32*FLOOR((L+2*LMIC)/32)) least significant bits of the output of the last KDF calls.

The confidentiality protection is done according to the following steps that extend TS 33.303 [4]:
1. Compute Key_calc_mask=(Encrypted_bits_mask1 XOR 0xFF..FF)∥0xFFFFFFFF∥ (Encrypted_bits_mask2 XOR 0xFF..FF)∥0xFFFFFFFF
   NOTE: Encrypted_bits_mask1 and Encrypted_bits_mask2 play a similar role to Encrypted_bits_mask in TS 33.303 but applied to the first part and the second part of the discovery message independently.
2. Obtain Keystream by means of a KDF as follows
   a. Keystream=″″
   b. HH=(Key_calc_mask AND (Message1∥ MIC∥ Message2∥ MIC2)) or alternatively HH=Hash ((Key_calc_mask AND (Message1∥ MIC∥ Message2∥ MIC2)))
   c. Fori=0 to FLOOR (L/32):
      i. Keystream=Keystream∥ KDF (DUCK, UTC-based counter, i, HH).
   d. Keystream=Keystream∥ LSB (KDF (DUCK, UTC-based counter, FLOOR (L/32)+1, HH), 8*(L−32*FLOOR (L/32)))
3. XOR (Keystream AND Encrypted_bits_mask) into the Message.

When calculating the message-specific confidentiality keystream for discovery, the following parameters shall be used to form the input S to the KDF that is specified in Annex B of TS 33.220 [5]:
FC=a unique identifier
P0=UTC-based counter associated with the discovery slot.
L0=length of above (i.e. 0x00 0x04).
P1=message fragment index.
L1=length of the above (i.e., 0x00 0x02).
P2=HH.
L2=length of HH.

The input key shall be the 256-bit DUCK.

For a discovery message of length L, a total of CEIL ((L)/32) calls to the KDF are required each with a different P1 value.

The message-specific confidentiality keystream is set to the concatenation of the KDF outputs of the first FLOOR((L)/32) KDF calls and the R=8 (L−32*FLOOR((L)/32)) least significant bits of the output of the last KDF call.

The protection of the first and second part of the message might also be done by means of different algorithms. For instance, the integrity and confidentiality protection of the first part of the message might be done as described above by means of a PRF as in TS 33.303. The integrity and confidentiality protection of the second part of the message might be done with one of the standard 5G confidentiality (e.g., 128-NEA1, 128-NEA2, 128-NEA3) and integrity (e.g., 128-NIA1, 128-NIA2, 128-NIA3) algorithms.

Which NIA or NEA algorithm is used might be signaled in the first part of the discovery message.

A proposed solution to address the problem in TS 33.503 v0.2.0 of protecting discovery messages of length longer than 256 bits by reusing the protection mechanisms specified in TS 33.303 requires the following changes: (a) in A.5 of TS 33.303, the time-hash-bitsequence keystream is set to L least significant bits of the output of the KDF, where L is the bit length of the discovery message to be scrambled and set to Min (the length of discovery message-16, 256). NOTE: The maximum length of the discovery message to be scrambled is limited to 256 bits; (b) in clause 6.1.3.4.3.2 of TS 33.303, MIC is set to a 32-bit random string if DUIK was not provisioned; (c) message-specific confidentiality is achieved by means of the 128-NEA algorithms are specified in Annex D in TS 33.501 [3]. The input parameters to the 128-NEA algorithms as described in Annex D in TS 33.501 are: KEY set to the 128 least significant bits of the output of the DUCK. KDF (DUCK, UTC-based counter, MIC), COUNT set to UTC-based counter, BEARER AND DIRECTION set to 0x00 and LENGTH set to the length of the discovery message-length of Message Type, UTC based counter LSB and MIC. The output keystream of the ciphering algorithm (output_keystream) is then masked with the Encrytped_bits_mask to produce the final keystream for the message-specific confidentiality protection (KEYSTREAM) where KEYSTREAM=output_keystream AND (Encrypted_bits_mask∥0xFF..FF) where the length of Encrypted_bits_mask is set to Min (the length of discovery message-48, 224). The KEYSTREAM is XORed with the discovery message for message-specific confidentiality protection; and (d) the ciphering algorithm for message-specific confidentiality is configured at the UE during the Discovery Request procedure.

However, this proposed solution has a number of issues.

First, KEY is computed as KDF (DUCK, UTC-based counter, MIC). A reason for this is to generate sessions key out of the DUCK. However, (i) including the MIC requires the MIC to be exchanged in the clear; (ii) it requires computing a KDF before encrypting any message increasing the CPU load; (iii) deriving a session key in this way does not increase the lifetime of the DUCK since the same KEY will be generated once the counter wraps around if the same discovery message is used. An embodiment to overcome this issue consists in using the DUCK or a part of it or a key derived (by means of a KDF) from the DUCK directly. On the other hand, this approach has the advantage, as described in above embodiments, that it allows generating a message-dependent key stream (since the MIC is used as input to the KDF), without having to pass the whole message to the KDF. The subsequent keystream generated by means of the NEA algorithms inherits this property.

An embodiment to overcome this issue if a session key is to be generated consists in generatig KEY=KDF (DUCK, UTC-time-in-seconds/rotation_rate) where the rotation_rate indicates how often the KEY needs to be rotated. For instance, rotation_rate might be 86400 seconds (1 day) meaning that once per day a new KEY is generated. This decreases the CPU load and increases the lifetime of the DUCK.

Second, the ciphering algorithm for message-specific confidentiality is configured at the UE during the Discovery Request procedure. For instance, in model A restricted discovery, the remote UE (or relay UE) signals its PC5 UE security capability that contains the list of supported ciphering algorithms by the UE. In the response, the core network, e.g., the 5G DDNMF in the HPLMN of the Announcing UE shall include the chosen PC5 ciphering algorithm in the Discovery Response message. The problem arises since there can be multiple announcing UEs and multiple monitoring UEs and the security capabilities might not be compatible to all of them support a chosen algorithm.

An embodiment to overcome this issue consists in the core network giving an indication of non-supported algorithm if the UE has sent a list of supported cipherig algorithms that not includes the chosen algorithm by the core network.

An embodiment to overcome this issue requires a UE that has received an indication of non supported algorithm or an algorithm choice that it does not support to not send or process discovery messages associated to the service.

Since the DUCK might not be provided, a part of the message might not be scrambled/encrypted leading to a privacy risk. An embodiment to overcome this issue requires the core network to configure a UE with the DUCK and requires the UE to apply the DUCK if a discovery message sent by the UE has a length of more than 256 bits. Alternatively, a UE must apply one of the embodiments above that allow updating TS 33.303 scrambling algorithms to protect messages that are longer than 256 bits.

TS 33.303, Clause 6.1.3.4.3.2 computes the MIC, applies confidentiality to the message, appends the MIC, and then scrambles the whole message. These steps are not modified in related proposals that however computes the KEYSTREAM as output_keystream AND (Encrypted_bits_mask∥ 0xFF..FF) where the length of Encrypted_bits_mask is set to Min (the length of discovery message—48, 224). Since the MIC is at the end of the message, it is always encrypted according to such proposals, and thus, the proposed solution in such proposals cannot operationally work since the MIC cannot be retrieved to compute the KEY used with the NEA algorithm. To solve the situation, it is proposed in an embodiment to modify Clause 6.1.3.4.3.2 in TS 33.303 to perform the following steps: (1) compute the MIC or another integrity component, (2) apply confidentiality to the message, (3) append the (confidentiality protected) message to the MIC and other unprotected fields (e.g. Message Type, UTC based counter LSB), and then (4) scramble (at least) the (first part of the) message. Clause 6.1.3.4.3.3 requires the inverse changes corresponding to this embodiment for the decoding of the message.

An alternative embodiment modifies the computation of KEYSTREAM as output_keystream AND (0x00 . . . 00∥ Encrypted_bits_mask∥ 0xFF..FF) where the length of Encrypted_bits_mask is set to Min (the length of discovery message-48, 224) where 0x00 . . . 00 is 48 bits long and 0xFF..FF has a length equal to the length of the discovery message minus the length of the Encrypted_bits_mask if the message is longer than 272 bits, otherwise 0. If this is done, Clause 6.1.3.4.3.2 in TS 33.303 performs the following steps (1) compute the MIC or another integrity component, (2) append the message to the MIC (and other unprotected fields), (3) apply confidentiality to the message and then (4) scramble the message. Steps (3) and (4) can be swapped. Clause 6.1.3.4.3.3 requires the inverse changes corresponding to this embodiment.

An alternative embodiment modifies Clause 6.1.3.4.3.2 in TS 33.303 to perform the following steps: (1) compute the MIC or another integrity component, (2) insert the MIC before optional fields such as Metadata or Group ID, (3) apply confidentiality to the message, (4) scramble (at least) the (first part of the) message. Steps (3) and (4) can be swapped. In this case, KEYSTREAM is computed as output_keystream AND (0x0000∥ Encrypted_bits_mask ∥ 0x00000000∥0xFF..FF) where 0x00000000 corresponds to the position of the MIC and 0x0000 correspond to the position of Message Type, UTC based counter LSB. Clause 6.1.3.4.3.3 requires the inverse changes corresponding to this embodiment.

An alternative embodiment modifies Clause 6.1.3.4.3.2 in TS 33.303 to perform the following steps: (1) compute the MIC or another integrity component, (2) apply confidentiality to the message, (3) insert the MIC, (4) scramble the message, in particular the first part of the message and the last 4 bytes of the message. Steps (3) and (4) can be swapped. In this case, KEYSTREAM is computed as output_keystream AND (0x0000∥ Encrypted_bits_mask∥ 0xFF..FF) where 0x0000 correspond to the position of Message Type, UTC based counter LSB. Clause 6.1.3.4.3.3 requires the inverse changes corresponding to this embodiment.

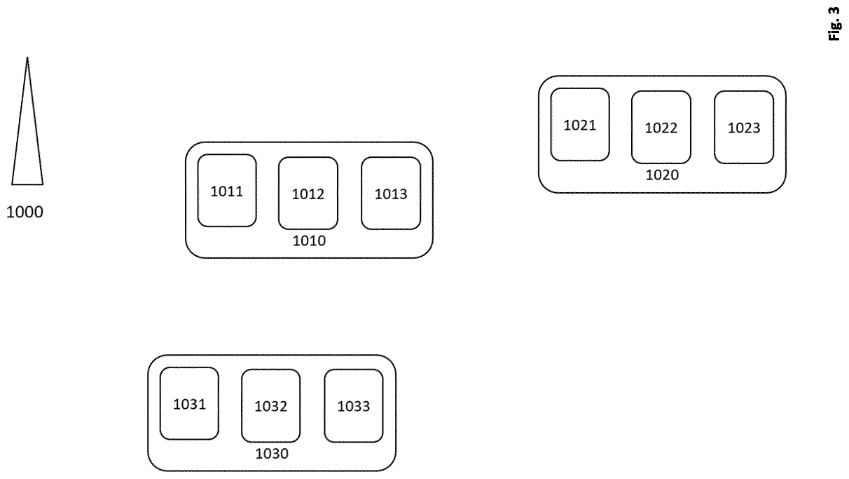

As explained throughout the previous embodiments, the proposed variants of the invention can be implemented in a network, for example a cellular network as a 5G network, shown on FIG. 3. A cell of the network is served by a primary station 1000. Under the coverage of the primary station 1000 (e.g. a gNB), a plurality of secondary stations can connect to the primary station. Some secondary station may be adapted to operate as relay stations 1010. Such a relay station may comprise a transmitter 1011, coupled with an transmit antenna, a receiver 1012 coupled with a receive antenna. Typically, the receive and transmit antenna are the same antenna. Further, depending on the technology, the antenna may be formed by an antenna array which may allow different transmission/reception modes, such as MIMO, transmit diversity, and operation on different sets of frequencies.

A controller 1013, for example a CPU or microcontroller (such as a microprocessor dedicated for the communication (baseband processor) or a main microprocessor of the device including the UE) operating with a software stored on an internal memory (e.g. ROM, EEPROM, SSD) is adapted to control the transmitter and the receiver and control the antennas. It is to be noted that some or all of the transmitter, the receiver and the controller may be part of a single baseband processor. In connection with the above described embodiments, the controller is adapted to establish a connection between the relay station 1010 and the primary station 1000. More specifically, the controller 1013 can configure the receiver 1012 for receiving in at least one first secure message from the primary station 1000 a first set of configuration parameters including attributes or service codes

The controller 1013 can control the transmitter 1011 and cause it to transmit at least one transmitted attribute or service code from the first set of configuration parameters. This attribute or service code can be broadcast for reception by other stations, for example like secondary station 1020 or 1030.

Typically, the relay station may be a UE, like a Sidelink compatible UE, which thus can behave as a relay station when configured to. Alternatively, the relay station may also be a another primary station, like an Access Point, or a gNB or a femtocell gNB.

The secondary station 1020 (or similary 1030) may typically be a UE, and comprises a transmitter 1021, a receiver 1022, both typically coupled to one or more antennas or antenna array. Further, the secondary station 1020 includes a controller 1023 which is adapted to control the receiver 1021, the transmitter 1022 and possibly other elements of the UEs. As for the relay station, the controller 1023 may be a processor or a CPU, and may operate thanks to a software.

The controller 1023 is able to cause the receiver 1021 and the transmitter 1022 to establish a connection with the primary station 1000. This includes for example configuring the receiver 1021 for receiving from the primary station 1000 in at least one second secure message a second set of configuration parameters including attributes or relay service codes linked to an upcoming data exchange with the relay station 1010.

The receiver 1021 may be adapted for receiving at least one transmitted attribute or service code from the relay station 1010 and the controller may be configured for determining whether the transmitted attribute or service code is included in the second set of configuration parameters or fulfil a policy in it and causing the transmitter to establish a direct communication with the relay station 1010 upon determination that the transmitted service code is included in the second set.

The secondary stations 1020 and 1030 may also be able to communicate with each other by means of relay station 1010.

A single unit or device may fulfill the functions of several items recited in the claims. The mere fact that certain measures are recited in mutually different dependent claims does not indicate that a combination of these measures cannot be used to advantage.

The described operations like those indicated in FIGS. 3 and 4 can be implemented as program code means of a computer program and/or as dedicated hardware of the related communication device or access device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

1. A method comprising:
preparing a message,
wherein the message comprises at least a parameter indicative of a type of service combined with a first communication key or an indication of a second communication key,
wherein the second communication key is used for communication with a second station;
performing an algorithm so as to generate a keystream by applying a key derivation function on at least a confidentiality key and freshness value,
ciphering the message with the keystream.

2. The method of claim 1, wherein generating the keystream comprises applying a key derivation function on at least a confidentiality key, a freshness value and the message.

3. The method of claim 1, wherein the ciphering comprises applying an XOR operation on the message and the keystream.

4. The method of claim 1, wherein the freshness value is a time value based on the Universal Time Coordinated.

5. The method of claim 1, further comprising computing a Message Integrity Check for the message.

6. The method of claim 5, wherein the message comprises the Message Integrity Check.

7. The method of claim 5, wherein generating the keystream comprises applying a key derivation function on at least a confidentiality key, a freshness value, the message and the Message Integrity Check.

8. The method of claim 1, further comprising selecting the confidentiality key from multiple available keys.

9. The method of claim 8,
wherein the confidentiality key is a Discovery User Confidentiality Key if a Discovery User Confidentiality Key is configured,
wherein the confidentiality key is a Discovery User Scrambling Key if a Discovery User Scrambling has been configured.

10. The method of claim 9,
wherein the keystream is obtained by applying an encryption algorithm if the Discovery User Confidentiality Key is configured, and
wherein the keystream is obtained by applying a scrambling algorithm if the Discovery User Confidentiality Key is not configured and if the Discovery User Scrambling has been configured.

11. The method of claim 9, wherein the message is not ciphered if the confidentiality key has not been configured.

12. The method of claim 1, wherein the keystream is obtained by applying a single algorithm regardless of the confidentiality key that has been configured.

13. The method of claim 8, further comprising computing a Message Integrity Check for the message using an integrity key, wherein the integrity key is the same as the selected confidentiality key.

14. The method of claim 1, further comprising applying a key derivation function so as to obtain a second confidentiality key, wherein the keystream is obtained by applying the second confidentiality key to a symmetric encryption algorithm.

15. The method of claim 14, wherein the symmetric encryption algorithm is an New radio Encryption Algorithm that has been selected by a core network or negotiated during a prior operation phase or signalled in the message.

16. The method of claim 1, wherein the parameter indicative of the type of service is a relay service code.

17. A first station comprising:
a transmitter circuit,
a receiver circuit,
a processor circuit and a memory circuit, wherein the memory is arranged to store instructions for the processor circuit,
wherein the processor circuit is arranged to prepare a message,
wherein the message comprises a parameter indicative of the type of service combined with a first communication key or an indication of a second communication key,
wherein the second communication key is used for communication with a second station,
wherein the processor circuit is arranged to perform an algorithm so as to generate a keystream by applying a key derivation function on at least a confidentiality key and freshness value,
wherein the processor circuit is arranged to cipher the message with the keystream.

18. A second station comprising:
a transmitter circuit,
a receiver circuit,
a processor circuit and a memory circuit, wherein the memory is arranged to store instructions for the processor circuit,
wherein the processor circuit is arranged to receive a ciphered message,
wherein the processor circuit is arranged to perform an algorithm so as to generate a keystream by applying a key derivation function on at least a confidentiality key and freshness value, and
wherein the processor circuit is arranged to decipher the message with the keystream.

19. (canceled)

20. A method comprising:
computing a Message Integrity Check-on the basis of a message;
combining the Message Integrity Check with the message;
computing a keystream at least on the basis of the Message Integrity Check; and
ciphering the message using a key word that is based on the keystream so as to obtain a cipher.

21. The method of claim 20, further comprising scrambling a portion of the cipher.

22. The method of claim 20, wherein the Message Integrity Check is used as fingerprint of the message in the computation of the keystream.

23. The method of claim 20, wherein the key word is a combination of the key stream with an encryption key mask.

24. The method of claim 23, wherein the combination is an AND operation.

25. A method comprising:
preparing a discovery message of length L bytes;
generating a pseudorandom sequence, wherein the output size of the pseudorandom sequence is L bytes;
applying a key derivation function of size B bytes Ceiling (L/B) times or a New radio Encryption Algorithm, wherein the pseudorandom sequence is dependent on at least a confidentiality key and a freshness value and a counter value; and
ciphering the message with the pseudorandom sequence.

26. The method of claim 25, where the input to the key derivation function comprises the result of the application of a bitwise “AND” function to a mask and the concatenation of message and Message Integrity Check.

27. The method of claim 25, wherein the input to the key derivation function or New radio Encryption Algorithm includes a function of at least a mask, or a message, or a Message Integrity Check.

28. The method of claim 25, wherein the message indicates the message length or a mask indicating the presence of optional fields so as to adjust the ciphering.

29. A method comprising:
receiving a discovery message, wherein the discovery message has a first portion and a second portion;
descrambling and/or decrypting the first portion of the discovery message using a first portion of a pseudorandom sequence,
verifying the integrity of the first portion of the discovery message by means of a Message Integrity Check in the first portion of the discovery message;
descrambling and/or decrypting the second portion of the discovery message with a second portion of the pseudorandom sequence if the integrity check of the first portion of the discovery message is successful and/or if a field in the first portion of the discovery message indicates the presence of the second portion of the discovery message.

30. The method of claim 29, wherein the second portion of the discovery message is descrambled and/or decrypted if the hash of the scrambled/encrypted second portion of the message matches a hash value included and verified in the first portion of the discovery message.

31. The method of claim 20, further comprising:
computing a Message Integrity Check on the basis of the message and a Discovery User Integrity Key if the Discovery User Integrity Key is configured;
setting the Message Integrity Check is to a random value if the Discovery User Integrity Key is not configured.

32. The method of claim 29, wherein the keystream is computed by a New radio Encryption Algorithm.

33. The method of claim 32, wherein the 32-bit count in the New radio Encryption Algorithm is set to the UTC based counter value and a BEARER field value is set to BEARER=0000, and DIRECTION field value is set to 0.

34. The method of claim 25,
wherein a protection of the discovery message is applied to the first portion of the discovery message and then to the second portion of the discovery message,
wherein protection of the first portion of the discovery message is different from the protection of the second portion of the discovery message.

35. A first comprising:
a transmitter circuit;
a receiver circuit; and
a processor circuit and a memory circuit, wherein the memory is arranged to store instructions for the processor circuit,
wherein the processor circuit is arranged to compute a Message Integrity Check on the basis of a message,
wherein the processor circuit is arranged to combine the Message Integrity Check with the message,
wherein the processor circuit is arranged to compute a keystream at least on the basis of the Message Integrity Check,
wherein the processor circuit is arranged to compute the message using a key word that is based on the keystream so as to obtain a cipher.

36. A first station operating in a communication system comprising
a transmitter circuit;
a receiver circuit; and
a processor circuit and a memory circuit, wherein the memory is arranged to store instructions for the processor circuit,
wherein the processor circuit is arranged to prepare a discovery message of length L bytes,
wherein the processor circuit is arranged to generate a pseudorandom sequence,
wherein the output size of the pseudorandom sequence is L bytes,
wherein the processor circuit is arranged to apply a key derivation function of size B bytes Ceiling (L/B) times or a New radio Encryption Algorithm,
wherein the pseudorandom sequence is dependent on at least a confidentiality key and a freshness value and a counter value,
wherein the processor circuit is arranged to cipher the message with the pseudorandom sequence.

37. A second station comprising:
a transmitter circuit;
a receiver circuit; and
a processor circuit and a memory circuit, wherein the memory is arranged to store instructions for the processor circuit,
wherein the processor circuit is arranged to receive an encrypted message and a Message Integrity Check,
wherein the processor circuit is arranged to obtain a key word, wherein the key word is based on the Message Integrity Check,
wherein the processor circuit is arranged to decrypt the encrypted message with the obtained key word,
wherein the processor circuit is arranged to check if the received Message Integrity Check is valid so as to check the integrity of the message.

38. (canceled)

39. A computer program stored on a non-transitory medium, wherein the computer program when executed on a processor performs the method as claimed in claim 1.

40. A computer program stored on a non-transitory medium, wherein the computer program when executed on a processor performs the method as claimed in claim 20.

41. A computer program stored on a non-transitory medium, wherein the computer program when executed on a processor performs the method as claimed in claim 25.

42. A computer program stored on a non-transitory medium, wherein the computer program when executed on a processor performs the method as claimed in claim 29.

43. The method of claim 29,
wherein a protection of the discovery message is applied to the first portion of the discovery message and then to the second portion of the discovery message,
wherein protection of the first portion of the discovery message is different from the protection of the second portion of the discovery message.
